(19) United States
(12) Patent Application Publication
(10) Pub. No.: US 2026/0261633 A1
(43) Pub. Date: Sep. 3, 2026

(54) EXTENDED PIXEL RESOLUTION ACTUATOR DRIVING APPARATUS, LASER PROJECTION DEVICE, DRIVING METHOD, AND STORAGE MEDIUM

(71) Applicant: HISENSE LASER DISPLAY CO., LTD., Qingdao (CN)

(72) Inventor: Rongrong Cui, Qingdao (CN)

(21) Appl. No.: 19/657,694

(22) Filed: Apr. 24, 2026

Related U.S. Application Data
(63) Continuation of application No. PCT/CN2024/126877, filed on Oct. 23, 2024.

(30) Foreign Application Priority Data
Oct. 25, 2023 (CN) 202311389658.1
Oct. 25, 2023 (CN) 202311395199.8
Oct. 25, 2023 (CN) 202311395207.9

(51) Int. Cl. H04N 9/31

(52) U.S. Cl. CPC H04N 9/312; H04N 9/3161; H04N 9/317; H04N 9/3197

(57) ABSTRACT

An extended pixel resolution (XPR) actuator driving apparatus includes a digital light processing (DPL) unit circuit, a delay circuit, a switch circuit, and an XPR actuator driving circuit; the DLP unit circuit is configured to output, in response to the DLP unit circuit being successfully configured, a configuration success command signal through the command signal output terminal, and an XPR actuator sub-frame synchronization signal through the sub-frame synchronization signal output terminal; the delay circuit is configured to output, in response to the input terminal of the delay circuit receiving the configuration success command signal, a turn-on signal through the output terminal of the delay circuit after a first delay; the switch circuit is configured to establish, in response to the control terminal of the switch circuit receiving the turn-on signal, an electrical connection between the input terminal of the switch circuit and the output terminal of the switch circuit.

### CROSS-REFERENCE TO RELATED APPLICATIONS

The present disclosure is a continuation of international application No. PCT/CN2024/126877, filed on Oct. 23, 2024, which claims priority to Chinese Patent Application No. 202311389658.1 filed on Oct. 25, 2023, and entitled “EXTENDED PIXEL RESOLUTION ACTUATOR DRIVING CIRCUIT, PROJECTION DEVICE, AND EXTENDED PIXEL RESOLUTION ACTUATOR DRIVING METHOD”, to Chinese Patent Application No. 202311395207.9, and entitled “APPARATUS AND METHOD FOR DIGITAL DRIVING WAVEFORM GENERATION OF EXTENDED PIXEL RESOLUTION ACTUATOR AND PROJECTION DEVICE”, and to Chinese Patent Application No. 202311395199.8, and entitled “EXTENDED PIXEL RESOLUTION ACTUATOR POWER SUPPLY CONTROL CIRCUIT AND LASER PROJECTION DEVICE”, the entire contents of which are incorporated herein by reference.

### TECHNICAL FIELD

The present disclosure relates to the field of laser projection technology, and in particular, relates to an extended pixel resolution actuator driving apparatus, a laser projection device, a driving method, and a storage medium.

### BACKGROUND

Laser projection device is a display technology that uses solid-state lasers of three primary colors of red, green, and blue (R, G, B) as the light source, which has advantages such as low power consumption and a longer service life, with the service life of the laser projection device being nearly 10 times that of traditional lamp light sources. The Laser projection device can truly reproduce the vibrant colors of the objective world and deliver excellent expressiveness. The color gamut coverage of laser display can reach more than 90% of the color space recognizable by the human eye, which is more than twice the color gamut coverage of traditional display technology, overcoming the shortcomings in color gamut space of the first three generations of display technology.

### SUMMARY

The present disclosure provides an extended pixel resolution actuator driving apparatus, a laser projection device, a driving method, and a storage medium. The technical solutions are as follows:

In a first aspect, an extended pixel resolution (XPR) actuator driving apparatus is provided. The XPR actuator driving apparatus includes a digital light processing (DLP) unit circuit, a delay circuit, a switch circuit, and an XPR actuator driving circuit; wherein a command signal output terminal of the DLP unit circuit is connected to an input terminal of the delay circuit, a sub-frame synchronization signal output terminal of the DLP unit circuit is connected to the XPR actuator driving circuit, an output terminal of the delay circuit is connected to a control terminal of the switch circuit, an input terminal of the switch circuit is connected to a power supply of the XPR actuator driving circuit, and an output terminal of the switch circuit is connected to a power input terminal of the XPR actuator driving circuit;
the DLP unit circuit is configured to output, in response to the DLP unit circuit being successfully configured, a configuration success command signal through the command signal output terminal and an XPR actuator sub-frame synchronization signal through the sub-frame synchronization signal output terminal, wherein the XPR actuator sub-frame synchronization signal is configured to instruct the XPR actuator driving circuit to drive an XPR actuator to deflect;
the delay circuit is configured to output, in response to the input terminal of the delay circuit receiving the configuration success command signal, a turn-on signal through the output terminal of the delay circuit after a first delay; and
the switch circuit is configured to establish, in response to the control terminal of the switch circuit receiving the turn-on signal, an electrical connection between the input terminal of the switch circuit and the output terminal of the switch circuit.

In a second aspect, a laser projection device is provided. The laser projection device includes an extended pixel resolution (XPR) actuator, and the XPR actuator driving apparatus provided in the first aspect, wherein the XPR actuator driving device is connected to the XPR actuator.

In a third aspect, a method for driving an extended pixel resolution (XPR) actuator is provided. The method includes: transmitting, in response to a digital light processing (DLP) unit circuit being successfully configured, an XPR actuator sub-frame synchronization signal; and supplying, after a first delay, power to an XPR actuator driving circuit, wherein the XPR actuator sub-frame synchronization signal is configured to instruct the XPR actuator driving circuit to drive an XPR actuator to deflect. The method can be applied to the XPR actuator driving apparatus provided in the first aspect above.

In a fourth aspect, a computer-readable storage medium is provided. The computer-readable storage medium stores at least one instruction, at least one program, a code set, or an instruction set, wherein the at least one instruction, the at least one program, the code set, or the instruction set is loaded and executed by a processor to perform the method for driving the XPR actuator provided in the third aspect.

In a fifth aspect, a computer program product is provided. The computer program product includes at least one program instruction. When the at least one program instruction executed by a processor, causes the processor to perform the method for driving the XPR actuator provided in the third aspect.

### BRIEF DESCRIPTION OF DRAWINGS

For clearer descriptions of the technical solutions in the embodiments of the present disclosure, the following briefly describes the accompanying drawings required for describing the embodiments. Apparently, the accompanying drawings in the following description illustrate merely some embodiments of the present disclosure, and those of ordinary skill in the art can still derive other drawings from these accompanying drawings without creative efforts.

FIG. 1 illustrates a schematic structural schematic of a laser projection device according to some embodiments;

FIG. 2 illustrates a schematic diagram of display resolution extension according to some embodiments;

FIG. 3 illustrates a schematic structural diagram of another laser projection device according to some embodiments;

FIG. 4 illustrates a schematic structural diagram of a lens assembly in a laser projection device according to some embodiments;

FIG. 5 illustrates a position diagram of a first sub-image when an extended pixel resolution (XPR) actuator deflects according to some embodiments;

FIG. 6 illustrates a position diagram of a second sub-image when an extended pixel resolution (XPR) actuator according to some embodiments;

FIG. 7 illustrates a schematic structural diagram of a single-axis extended pixel resolution (XPR) actuator according to some embodiments;

FIG. 8 illustrates a schematic structural diagram of an extended pixel resolution (XPR) actuator driving device according to some embodiments;

FIG. 9 illustrates a circuit schematic diagram of an extended pixel resolution (XPR) actuator power control device according to some embodiments;

FIG. 10 illustrates a circuit schematic diagram of another extended pixel resolution (XPR) actuator power supply control device according to some embodiments;

FIG. 11 illustrates a circuit schematic diagram of another extended pixel resolution (XPR) actuator power control device according to some embodiments;

FIG. 12 illustrates a partial circuit schematic diagram of a laser projection device according to some embodiments;

FIG. 13 illustrates a schematic structural diagram of an extended pixel resolution (XPR) actuator driving circuit according to some embodiments;

FIG. 14 illustrates a schematic structural diagram of another extended pixel resolution (XPR) actuator driving circuit according to some embodiments;

FIG. 15 illustrates a schematic structural diagram of an operational amplifier module according to some embodiments;

FIG. 16 illustrates a schematic structural diagram of another extended pixel resolution (XPR) actuator driving circuit according to some embodiments;

FIG. 17 illustrates a structural schematic of another extended pixel resolution (XPR) actuator driving circuit according to some embodiments;

FIG. 18 illustrates a waveform diagram of a first driving voltage according to some embodiments;

FIG. 19 illustrates a waveform diagram of a second driving voltage according to some embodiments;

FIG. 20 illustrates waveform diagrams of driving signals according to some embodiments;

FIG. 21 illustrates a schematic structural diagram of a digital waveform generation module according to some embodiments;

FIG. 22 illustrates a schematic diagram of an analog driving waveform and a digital driving waveform according to some embodiments;

FIG. 23 illustrates a timing diagram of a sub-frame synchronization according to some embodiments;

FIG. 24 illustrates a schematic diagram of digital driving waveform generation according to some embodiments;

FIG. 25 illustrates a schematic diagram of a waveform output working principle according to some embodiments;

FIG. 26 illustrates a structural block diagram of another digital waveform generation module according to some embodiments;

FIG. 27 illustrates a structural block diagram of another digital waveform generation module according to other embodiments;

FIG. 28 illustrates a structural block diagram of another digital waveform generation module according to other embodiments;

FIG. 29 illustrates a structural block diagram of another digital waveform generation module according to other embodiments;

FIG. 30 illustrates a flowchart of a method for driving an extended pixel resolution (XPR) actuator according to some embodiments; and

FIG. 31 illustrates a flowchart of another method for driving an extended pixel resolution (XPR) actuator according to some embodiments.

### DETAILED DESCRIPTION

To make the objectives and embodiments of the present disclosure clearer, the exemplary embodiments of the present application will be clearly and completely described below with reference to the accompanying drawings in the exemplary embodiments of the present disclosure. Obviously, the described exemplary embodiments are only part of the embodiments of the present disclosure, rather than all of the embodiments.

It should be noted that the brief descriptions of terms in the present disclosure are merely intended to facilitate understanding of the embodiments described below, and are not intended to limit the embodiments of the present disclosure. Unless otherwise stated, these terms should be construed in accordance with their ordinary and usual meanings.

The terms “comprise,” “include,” and “have” and any variations thereof are intended to be inclusive rather than exclusive. For example, a product or device including a series of components is not necessarily limited to all the components explicitly listed, but may include other components that are not explicitly listed or are inherent to such product or device.

Resolution is also an important characteristic of a laser projection device. The higher the resolution, the greater the precision of the images projected onto the screen, the more information displayed, and the clearer the picture. However, the resolution of the laser projection device is limited by hardware technology, making it difficult to improve resolution. At present, many laser projection devices use digital micromirror devices (DMDs) as a key component, and the resolution of the laser projection device is mainly determined by the resolution of the DMD. With the help of micro-extended pixel resolution actuator (referred to as XPR actuator) technology, high-resolution images can be projected using a low-resolution DMD. One frame of high-resolution image is divided into two low-resolution sub-images, and then the XPR actuator in the DMD is controlled to deflect, such that the two sub-images are sequentially imaged with positional offset within one image display period, thereby achieving high-resolution image projection. How to ensure the reliability and accuracy of the XPR actuator deflection has become a research focus in the industry.

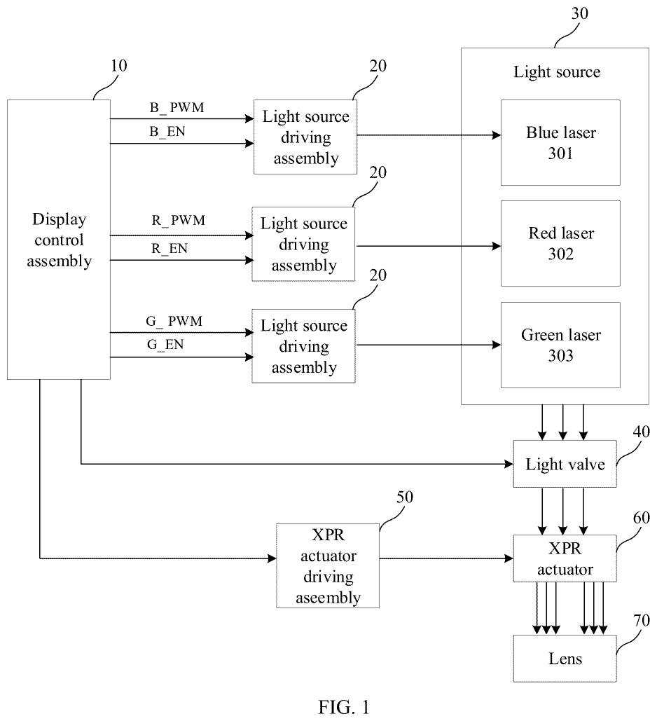

The embodiments of the present disclosure provide an extended pixel resolution actuator (XPR) driving apparatus applied to a laser projection device (which may be briefly referred to as a projection device). FIG. 1 is a schematic structural diagram of a laser projection device according to some embodiments of the present disclosure. As shown in FIG. 1, the laser projection device may include: a display control assembly 10, a light source driving assembly 20, a light source 30, a light valve 40, an XPR actuator driving assembly 50, an XPR actuator 60, and a lens 70. The display control assembly 10 is connected to the light source driving assembly 20, the light valve 40, and the XPR actuator driving assembly 50, respectively. The light source driving assembly 20 is also connected to the light source 30, and the XPR actuator driving assembly 50 is also connected to the XPR actuator 60. The XPR actuator 60 is disposed on the light-output side of the light valve 40, and the lens 70 is disposed on the light-output side of the XPR actuator 60. That is, the XPR actuator 60 is disposed between the light valve 40 and the lens 70. In some embodiments, the display control assembly may also be referred to as a processor, and the light source driving assembly may also be referred to as a laser driving assembly. The XPR actuator driving apparatus provided in the embodiments of the present disclosure may include the display control assembly 10 and the XPR actuator driving assembly 50. The XPR actuator driving assembly 50 includes an XPR actuator driving circuit.

The light source driving assembly 20 may be one or a plurality (the plurality includes two or more, with three in FIG. 1), and the light source 30 includes one or a plurality of groups of lasers, with the plurality of groups including two or more groups. Each group of lasers may include one or a plurality of lasers, and one group of lasers corresponds to one light source driving assembly 20, with different groups of lasers corresponding to different light source driving assemblies 20. The display control assembly 10 is connected to each light source driving assembly 20, and each light source driving assembly 20 is connected to a corresponding group of lasers.

The light source 30 may be a laser light source. For example, referring to FIG. 1, the laser projection device includes three light source driving assemblies 20. Correspondingly, the light source 30 includes three groups of lasers that are in one-to-one correspondence with the three laser driving assemblies 20. These three groups of lasers may be a blue laser 301, a red laser 302, and a green laser 303, respectively. The blue laser 301, red laser 302, and green laser 303 are connected to the corresponding light source driving assemblies 20, respectively. The blue laser 301 emits blue laser light, the red laser 302 emits red laser light, and the green laser 303 emits green laser light. This laser projection device may be referred to as a three-color laser projection device.

In one possible implementation, in the case where the light source 30 in the laser projection device includes two groups of red lasers 302, one group of blue lasers 301, and one group of green lasers 303 that are integrated, the laser projection device may be referred to as a full-color laser projection device. The blue lasers 301 in the laser projection device may be arranged between the red lasers 302 and the green lasers 303. Since the blue lasers 301 can withstand higher temperatures, arranging the blue lasers 301 between the red lasers 302 and the green lasers 303 is more conducive to rapid heat dissipation of the red lasers 302 and the green lasers 303, thereby improving the reliability of the integrated plurality of groups of lasers.

The display control assembly 10 outputs a blue PWM signal B_PWM corresponding to the blue laser 301 based on the blue primary color component of each frame of sub-image, and outputs an enable signal B_EN corresponding to the blue laser 301 based on the lighting duration of the blue laser 301 during the driving cycle. The display control assembly 10 transmits the blue PWM signal B_PWM and the enable signal B_EN corresponding to the blue primary color component of each frame of sub-image to the light source driving assembly 20, and the light source driving assembly 20 is the light source driving assembly corresponding to the blue laser 301. The light source driving assembly 20 corresponding to the blue laser 301 may provide, in response to the blue PWM signal B_PWM and the enable signal B_EN, a corresponding laser driving current to the blue laser 301 to drive the blue laser 301 to emit blue laser light.

The display control assembly 10 outputs a red PWM signal R_PWM corresponding to the red laser 302 based on the red primary color component of each frame of sub-image, and outputs an enable signal R_EN corresponding to the red laser 302 based on the lighting duration of the red laser 302 during the driving cycle. The display control assembly 10 transmits the red PWM signal R_PWM and the enable signal R_EN corresponding to the red primary color component of each frame of sub-image to the light source driving assembly 20, and the light source driving assembly 20 is the light source driving assembly corresponding to the red laser 302. The light source driving assembly 20 corresponding to the red laser 302 may provide, in response to the red PWM signal R_PWM and the enable signal R_EN, a corresponding laser driving current to the red laser 302 to drive the red laser 302 to emit red laser light.

The display control assembly 10 outputs a green PWM signal G_PWM corresponding to the green laser 303 based on the green primary color component of each frame of sub-image, and outputs an enable signal G_EN corresponding to the green laser 303 based on the lighting duration of the green laser 303 during the driving cycle. The display control assembly 10 transmits the green PWM signal G_PWM and the enable signal G_EN corresponding to the green primary color component of each frame of sub-image to the light source driving assembly 20, and the light source driving assembly 20 is the light source driving assembly corresponding to the green laser 303. The light source driving assembly 20 corresponding to the green laser 303 may provide, in response to the green PWM signal G_PWM and the enable signal G_EN, a corresponding laser driving current to the green laser 303 to drive the green laser 303 to emit green laser light.

After controlling the laser to start emitting laser light, the display control assembly 10 may control the light valve 40 to flip according to the primary color grayscale value of the pixels in each frame of sub-image. The primary color grayscale value is realized by the duration of the micromirror flipping in the light valve 40. Cooperating with the light of the corresponding color irradiating the light valve 40, the grayscale of the three primary colors of the corresponding pixel is formed, thereby sequentially projecting and displaying a plurality of frames of sub-images onto the projection screen (which may also be referred to as a display screen). The display control assembly further controls the XPR actuator 60 to deflect, so as to display the frame of sub-image at different positions of the display screen 130.

In the embodiment of the present disclosure, the plurality of frames of sub-images include two frames of sub-images. When the laser light emitted by each laser irradiates the light valve 40, the display control assembly 10 may control the light valve 40 to flip based on the primary color grayscale value of the pixels in each frame of sub-image, so as to sequentially project and display the two frames of sub-image onto the projection screen. The primary color grayscale values may be red, green, and blue (RGB) color grayscale values.

In some embodiments, the display control component includes a field-programmable gate array (FPGA). The digital waveform generation module in the XPR actuator driving circuit provided in the embodiments of the present disclosure may be integrated into the FPGA. In this way, the digital driving waveform signal (referred to as digital driving waveform) for driving the XPR actuator may be generated by the FPGA, saving device space and facilitating further miniaturization of the projection device.

In one possible implementation, the display control assembly 10 may include a digital light processing chip (DLPC). Illustratively, the digital light processing chip may be DLPC 3437 or another DLPC, which is not limited in the embodiments of the present disclosure. The light valve 40 may be a digital micro-mirror device (DMD) or another device with similar functions. The XPR actuator 60 may be used to shift different frames of sub-image to different positions on the projection screen, thereby achieving the superimposed display of a plurality of frames of sub-image (also referred to as sub-frame image) for one frame of image, and thus expanding the resolution of the laser projection device. In the embodiments of the present disclosure, the XPR actuator 60 may have two deflection positions; that is, the XPR actuator 60 may shift the sub-image to two different positions on the projection screen, thereby doubling the resolution of the laser projection device, such as increasing the resolution from 720p to 2K, or from 3K to 4K.

In the embodiments of the present disclosure, the plurality of frames of sub-image are obtained by splitting the target image to be projected. The resolution of the target image is greater than that of the light valve, and the resolution of each split frame of sub-image is not greater than that of the light valve, for example, may be equal to the resolution of the light valve. For example, the resolution of the target image may be M×N, where M is the number of pixels per row in the target image, and N is the number of pixels per column. The resolution of the light valve is M1×N1, where M1 is the number of pixels per row in the image that can be projected and displayed by the light valve, and N1 is the number of pixels per column. The resolution of each frame of sub-image may be m1×n1, where m1 is the number of pixels per row in each frame of sub-image, and n1 is the number of pixels per column. M, N, M1, N1, m1, and n1 are all positive integers greater than 1, and M is greater than M1, N is greater than N1, m1 is not greater than M1, and n1 is not greater than N1.

Illustratively, the resolution of the target image may be 3840×2160, where M is 3840, and N is 2160. The resolution of the light valve may be 2880×1620, where M1 is 2880, and N1 is 1620. The resolution of the frame of sub-image is 2715×1527, where m1 is 2715 (approximately 3840 multiplied by the square root of one half) and n1 is 1527 (approximately 2160 multiplied by the square root of one half), such that the sum of the resolutions of the two frames of sub-image, 2715×1527×2, is approximately equal to the resolution of the target image, 3840×2160, thereby achieving a doubling of the displayed image resolution using a low-resolution light valve. The resolution of the target image, 3840×2160, is higher than the resolution of the light valve, 2880×1620, and the resolution of each frame of sub-image, 2715×1527, is less than the resolution of the light valve, 2880×1620.

In one possible implementation, one frame of target image to be projected and displayed (which may be an image with a lower resolution, such as a 720p resolution image) is processed into two frames of sub-image by the display control assembly 10. During the projection and display of each frame of sub-image, the display control assembly 10 may control the XPR actuator driving assembly 50 to generate a digital driving waveform signal corresponding to one frame of sub-image. The XPR actuator driving assembly 50 converts the digital driving waveform signal into an analog driving waveform signal (referred to as analog driving waveform), and generates a first driving voltage and a second driving voltage with opposite phases based on the analog driving waveform signal. The first driving voltage is applied to the positive terminal of the coil of the XPR actuator, and the second driving voltage is applied to the negative terminal of the coil of the XPR actuator. The voltage difference (i.e., the driving signal) between the first driving voltage and the second driving voltage is used to drive the XPR actuator 60 to deflect. Different frames of sub-image correspond to different digital driving waveform signals, thereby allowing the projection of two frames of sub-image onto different positions on the projection screen. This enables the superimposed display of the two frames of sub-image to display one frame of target image, which means that an image with a lower resolution can be displayed with a higher resolution. The voltage direction of the driving signal may remain unchanged, and thus the deflection direction of the XPR actuator 60 is fixed, and the waveform of the driving signal may be a sine wave.

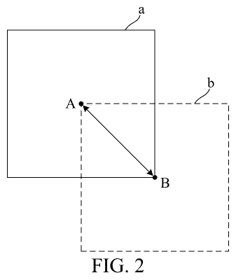

Illustratively, referring to FIG. 2, the XPR actuator 60 can deflect back and forth between position A and position B under the driving of the aforementioned driving signal. During the projection display of sub-image a of one frame of target image, the display control assembly 10 controls the XPR actuator driving assembly 50 to generate a digital driving waveform signal corresponding to the sub-image a. The XPR actuator driving assembly 50 then applies a driving signal to the XPR actuator 60 based on the digital driving waveform signal, causing the XPR actuator 60 to deflect to position A. Afterwards, the XPR actuator 60 remains unchanged, thus completing the display of the sub-image a. During the projection display of a sub-image b of the frame of target image, the display control assembly 10 controls the XPR actuator driving assembly 50 to generate a digital driving waveform signal corresponding to the sub-image b. The XPR actuator driving assembly 50 then applies a driving signal to the XPR actuator 60 based on the digital driving waveform signal, causing the XPR actuator 60 to deflect to position B. Afterwards, the XPR actuator 60 remains unchanged, thus completing the display of the sub-image b. Thus, for each frame of target image, two frames of sub-image thereof are all projected at different deflection positions of the XPR actuator 60, thereby achieving the projection display of different frames of sub-image at different positions on the projection screen.

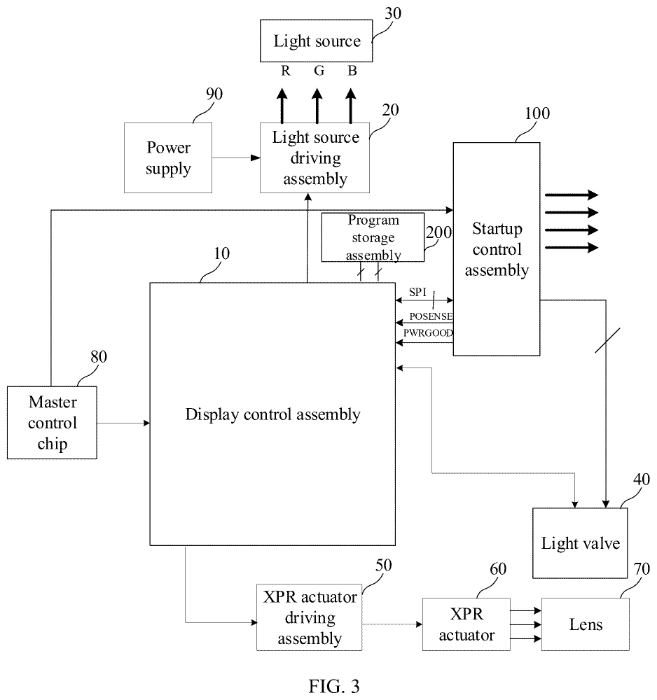

FIG. 3 is a structural schematic diagram of another laser projection device according to some embodiments of the present disclosure. In some embodiments, referring to FIG. 3, the laser projection device may also include a master control chip 80, a power supply 90, a startup control assembly 100, and a program storage assembly 200. The master control chip 80 is connected to the startup control assembly 100 and the display control assembly 10, respectively. The power supply 90 is connected to the light source driving assembly 20, and the program storage assembly 200 is connected to the display control assembly 10. In some embodiments, the startup control assembly may include a power management chip. The laser projection device may be a projection television or other device.

The master control chip 80 sends a start command to the startup control assembly 100. The startup control assembly 100 starts working upon receiving the start command. The startup control assembly 100 sequentially outputs 1.1 volts (V), 1.8V, 3.3V, 2.5V, and 5V to the display control assembly 10 according to the power-on sequence to supply power to the display control assembly 10. After the supply voltage and timing are correct, the startup control assembly 100 sends a reset signal to the display control assembly 10, reads the program from the externally connected program storage assembly 200, and performs initialization. At this point, the entire laser projection device starts working. Upon receiving the reset signal sent by the startup control assembly 100, the display control assembly 10 configures the startup control assembly 100 through the serial peripheral interface (SPI) and instructs the startup control assembly 100 to start supplying power to the light valve 40. Then, the startup control assembly 100 outputs three voltages to the light valve 40, namely voltage bias (VBIAS) (such as 18V), voltage reset (VRST) (such as −14V), and voltage offset (VOFS) (such as 10V). After the voltage of the light valve 40 is normal, the light valve 40 starts working. The display control assembly 10 sends the base color grayscale value of the sub-image to the light valve 40 through LVDS communication to achieve the display of the sub-image. The power supply in the laser projection device may be converted from 100V to 240V AC to DC by a power board to supply power to various assemblies.

In some embodiments, referring to FIG. 3, the laser projection device also includes a detector 101. The detector 101 is connected to the display control assembly 10. The detector 101 may be used for calibrating the XPR actuator. The detector 101 may be a camera, a charge-coupled device (CCD), or other devices.

Before projecting the target image, the XPR actuator is calibrated first. During the calibration phase of the XPR actuator, the display control assembly 10 is configured to split the XPR actuator calibration image into a first sub-image (also known as a first sub-frame) and a second sub-image (also known as a second sub-frame). For the first sub-frame, the XPR actuator 60 is moved to a first position, and the first sub-image is projected onto a first display position on the projection screen through the lens. For the second sub-frame, the XPR actuator 60 is moved to a second position, and the second sub-image is projected onto a second display position on the projection screen through the lens. Then, based on the offset between the first sub-image and the second sub-image collected by the detector 101, the first and second positions of the XPR actuator 60 are calibrated.

In the process of projecting the XPR actuator calibration image for display, the master control chip 80 of the laser projection device may decode the image signal of the XPR actuator calibration image and send the decoded image signal of the XPR actuator calibration image to the display control assembly 10 at a certain frequency (such as 60 Hertz (Hz)). Correspondingly, the display control assembly 10 may receive the decoded image signal of the XPR actuator calibration image sent by the master control chip 80. Afterwards, the display control assembly 10 may split the received decoded image signal of the XPR actuator calibration image into a signal for the first sub-image and a signal for the second sub-image, thereby dividing the XPR actuator calibration image into two frames of sub-image.

After dividing the XPR actuator calibration image to be projected into the first sub-image and the second sub-image, the display control assembly 10 may output at least one enable signal corresponding to each of the three primary colors of each frame of sub-image, and transmit the at least one enable signal to the corresponding light source driving assembly 20. The at least one enable signal may also be referred to as a laser current control signal. The laser current control signal is used to instruct the light source driving assembly 20 to provide a corresponding laser driving current to the laser connected thereto, so as to drive the laser to emit laser light. The laser current control signal may be a pulse width modulation (PWM) signal.

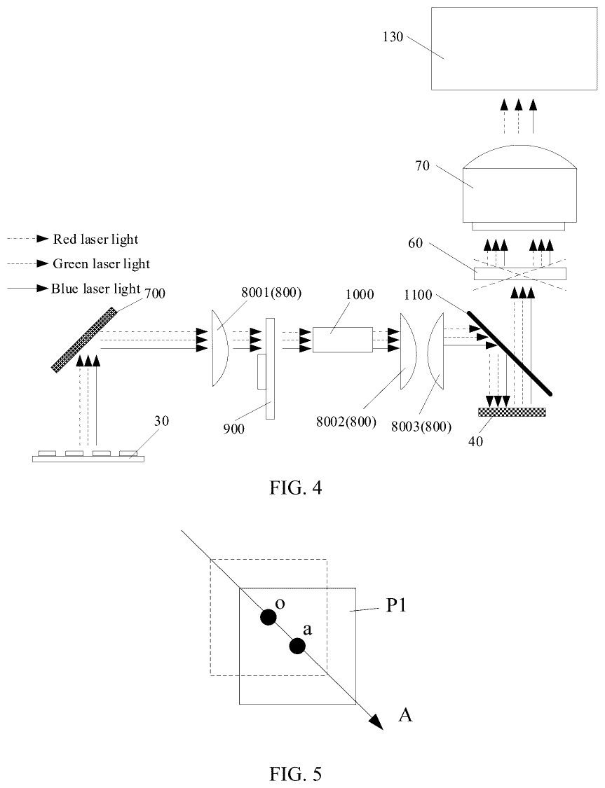

FIG. 4 is a schematic structural diagram of a lens assembly in a laser projection device according to some embodiments of the present disclosure. The lens assembly may include four reflective mirrors 700, a lens assembly 800, a diffusion wheel 900, a light pipe 1000, a total internal reflection (TIR) lens 1100, and a lens 70. The laser projection device further includes a display screen 130 (i.e., a projection screen), and the display screen is disposed on the light-output side of the lens 70. The lens assembly 800 includes a first lens 8001, a second lens 8002, and a third lens 8003, with each laser corresponding to one reflective mirror 700. In some embodiments, the XPR actuator 60 may be regarded as a component of the lens assembly. The XPR actuator 60 may be disposed on the light-input side of the lens 70 and on the light-output side when the TIR lens 1100 is in full transmission. That is, the XPR actuator 60 may be disposed between the lens 70 and the TIR lens 1100.

It should be understood that the four reflective mirrors in FIG. 4 are in one-to-one correspondence with the four lasers, and the four lasers may include the two groups of red lasers 302, one group of blue lasers 301, and one group of green lasers 303 introduced above.

During projection and display of the first sub-image, the blue laser light emitted by the blue laser 301 is reflected by the reflective mirror 700 at a corresponding position, condensed by the first lens 8001, homogenized by passing through the diffusion wheel 900, and further subjected to total internal reflection homogenization through the light pipe 100. The red laser light emitted by the red laser 302 is reflected by the reflective mirror 700 at a corresponding position, condensed by the first lens 8001, subjected to speckle reduction and chromaticity homogenization by passing through the diffusion wheel 900, and further subjected to total internal reflection homogenization through the light pipe 1000. The green laser light emitted by the green laser 303 is reflected by the reflective mirror 700 at a corresponding position, condensed by the first lens 8001, subjected to speckle reduction and chromaticity homogenization by passing through the diffusion wheel 900, and further subjected to total internal reflection homogenization through the light pipe 1000. The homogenized blue, red, and green laser lights from the light pipe 1000 are sequentially shaped by the second lens 8002 and the third lens 8003 in a time-division manner, and enter the TIR lens 1100 for total internal reflection. When the three primary color lights (i.e., blue laser light, red laser light, and green laser light) irradiate the light valve 40 in a time-sequential manner, the display control assembly 10 controls the light valve 40 to flip according to the primary color grayscale values of pixels in the first sub-image. The flipped light valve 40 reflects the light that has been totally internally reflected by the TIR lens 1100, passes through the TIR lens 1100 again, is deflected by the XPR actuator 60, and finally projects onto the display screen 130 through the lens 70, achieving the display of the first sub-image on the display screen 130. Subsequently, the second sub-image is similarly projected and displayed in sequence.

During the projection and display of each frame of sub-image, the display control assembly 10 may transmit an XPR actuator current control signal corresponding to one frame of sub-image to the XPR actuator driving assembly 50. The XPR actuator current control signal is used to control the XPR actuator driving assembly 50 to provide an XPR actuator driving current to the XPR actuator 60, thereby driving the XPR actuator 60 to deflect. Alternatively, the display control assembly 10 may transmit an XPR actuator voltage control signal corresponding to one frame of sub-image to the XPR actuator driving assembly 50. The XPR actuator voltage control signal is used to control the XPR actuator driving assembly 50 to provide an XPR actuator driving voltage to the XPR actuator 60, thereby driving the XPR actuator 60 to deflect. For example, under the control of the XPR actuator voltage control signal, the XPR actuator driving assembly 50 generates a digital driving waveform signal corresponding to one frame of sub-image, converts the digital driving waveform signal into an analog driving waveform signal, and generates a first driving voltage and a second driving voltage with opposite phases based on the analog driving waveform signal. The first driving voltage is applied to the positive terminal of the XPR actuator coil, and the second driving voltage is applied to the negative terminal of the XPR actuator coil. The voltage difference between the first driving voltage and the second driving voltage (i.e., the driving signal, or driving voltage) is used to drive the XPR actuator 60 to deflect.

The XPR actuator current control signals or the XPR actuator voltage control signals corresponding to different frames of sub-image are different, such that a plurality of frames of sub-image can be projected onto different positions on the projection screen, thereby achieving the superimposed display of the plurality of frames of sub-image, and further displaying the target image on the display screen 130. In addition, during the projection and display of the plurality of frames of sub-image, the current direction of the XPR actuator driving current may be alternately reversed, and the waveform of the XPR actuator driving current may be a sine wave.

Taking the XPR actuator circuit control signal as an example, during the projection and display of each frame of sub-image, the light valve 40 receives irradiation from the three primary color lights in a time-sequential manner. When the light valve 40 receives irradiation from the target primary color light among the three primary color lights, the display control assembly 10 may transmit the XPR actuator current control signal corresponding to the sub-image to the XPR actuator driving assembly 50. The XPR actuator current control signal is used to control the XPR actuator driving assembly 50 to provide XPR actuator driving current to the XPR actuator 60, driving the XPR actuator 60 to deflect. Afterwards, the XPR actuator 60 remains unchanged, thus completing the display of one frame of image. Subsequently, during the display of the next frame of sub-image, the display control assembly 10 and the XPR actuator driving assembly 50 may drive the XPR actuator 60 to deflect again. And so on, thus achieving the projection display of different frames of sub-image onto different positions on the projection screen.

During the projection and display of the first sub-image, the light valve 40 receives irradiation from the three primary color lights in a time-sequential manner. When the light valve 40 receives irradiation from the target primary color light among the three primary color lights, the display control assembly 10 may transmit a first XPR actuator current control signal to the XPR actuator driving assembly 50. The first XPR actuator current control signal is used to control the XPR actuator driving assembly 50 to drive the XPR actuator 60 to rotate to a first position.

During the projection and display of the second sub-image, the light valve 40 receives irradiation from the three primary color lights in a time-sequential manner. When the light valve 40 receives irradiation from the target primary color light among the three primary colors, the display control assembly 10 may transmit a second XPR actuator current control signal to the XPR actuator driving assembly 50. The second XPR actuator current control signal is used to control the XPR actuator driving assembly 50 to drive the XPR actuator 60 to rotate to a second position.

As shown in FIG. 5, during the projection and display of the first sub-image P1, the light valve 40 receives irradiation from the three primary color lights in a time-sequential manner. When the light valve 40 receives irradiation from the blue primary color light among the three primary colors, the display control assembly 10 may transmit the first XPR actuator current control signal to the XPR actuator driving assembly 50. The XPR actuator driving assembly 50 then provides the first XPR actuator driving current to the coil in the XPR actuator 60, and the XPR actuator 60 can rotate a certain angle driven by the first XPR actuator driving current. This allows the center pixel in the first sub-image P1 to be shifted a certain distance in the positive direction of the A axis relative to the coordinate origin o, that is, the center pixel in the first sub-image P1 is located at position a on the A axis.

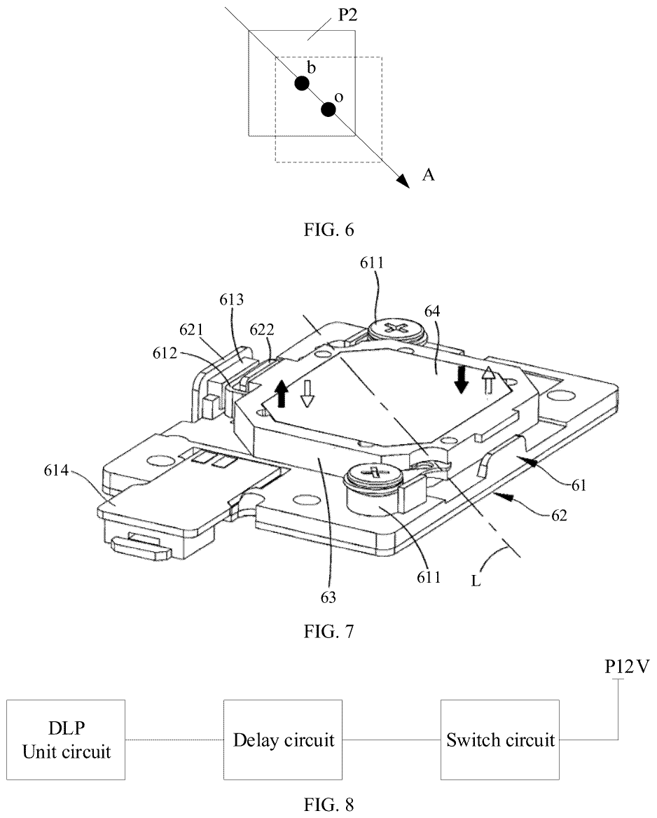

As shown in FIG. 6, during the projection and display of the second sub-image P2, the light valve 40 receives irradiation from the three primary color lights in a time-sequential manner. When the light valve 40 receives irradiation from the blue primary color light among the three primary colors, the display control assembly 10 may transmit the second XPR actuator current control signal to the XPR actuator driving assembly 50. The XPR actuator driving assembly 50 then supplies the second XPR actuator driving current to the coil in the XPR actuator 60, and the XPR actuator 60 can rotate a certain angle under the driving of the second XPR actuator driving current. This allows the center pixel in the second sub-image P2 to be shifted a certain distance in the negative direction of the A axis relative to the coordinate origin o, that is, the center pixel in the second sub-image P2 is located at position b on the A axis.

The XPR actuator current control signals corresponding to different frames of sub-image are different, so the XPR actuator 60 may be driven to deflect to different positions, thereby superimposing and displaying the plurality of frames of sub-image on the display screen 130. Without losing pixel information of the target image, it achieves the display of high-resolution target images on a low-resolution laser projection device.

FIG. 7 is a schematic structural diagram of an XPR actuator according to some embodiment of the present disclosure. Referring to FIG. 7, the XPR actuator may include a base 61, a fixing plate 62, a spring plate (not shown in the figures and covered by a swinging member 63), the swinging member 63, and an optical lens 64. The base 61 has a first hollowed-out region (also referred to as a first light-transmitting region), one side of the base 61 is provided with two pillars 611, and the two pillars are disposed at two ends of a diagonal line of the first hollowed-out region. That is, one pillar 611 is disposed at each end of the diagonal line of the first hollowed-out region. The side of the base 61 is also provided with a magnetic component disposed at one edge of the first hollowed-out region. That is, the magnetic component is disposed at one edge of the first hollowed-out region. The magnetic component includes a coil 612 and a magnet 613. The end of the base 61 is provided with a connector 614, and the connector is connected to the coil 612 and the output terminal of the XPR actuator driving circuit, respectively. The fixing plate 62 is disposed on the side of the base 61 opposite to the magnetic component, the fixing plate 62 has a second hollowed-out region (also referred to as a second light-transmitting region), and the fixing plate 62 is used to fix the base 61. The spring plate is fixed on the two pillars 611, for example, both ends of the spring plate are respectively fixed on one pillar 611, with one pillar 611 fixing one end of the spring plate. The swinging member 63 is covered on the spring plate with the two pillars 611 as fulcrums, the swinging member 63 has a third hollowed-out region (also referred to as a third light-transmitting region), and the swinging member 63 is used to carry the optical lens 64. The orthographic projection of the optical lens 64 on the base 61 and the orthographic projection of the second hollowed-out region on the base 61 both overlap with the first hollowed-out region.

In one possible implementation, referring to FIG. 7, one side of the second hollowed-out region of the fixing plate 62 is provided with a support piece 621 and an insertion piece 622 extending through the base 61. The support piece 621 abuts against the side of the base 61, and the support piece 621 and insertion piece 622 are used to fix the coil 612 and magnet 613. The XPR actuator provided in the embodiments is a two-dimensional XPR actuator or a single-axis XPR actuator. When the XPR actuator driving circuit inputs a driving signal to the coil 612 through the connector 614, the magnetic assembly produces an attraction or repulsion effect. Due to the attraction or repulsion effect, the side end of the swinging member 63 swings around the virtual axis L (i.e., a diagonal line of the swinging member 63, which is also the diagonal line where the two pillars 611 are located), thereby projecting two frames of sub-image to different positions, doubling the resolution of the laser projection device. The position of the virtual axis L shown in FIG. 7 deviates from the actual swinging axis, which is determined by the diagonal line where the pillars of the specific device are located.

In the related art, during the high-speed vibration process of the XPR actuator, DC high-voltage driving conditions are prone to occur when the XPR actuator is switched on or off, resulting in burnout of the XPR actuator coil and the abnormal operation of the XPR actuator. For example, in the laser projection device, the power supply of each component is immediately powered on when the device is turned on, but at this time, the XPR actuator driving waveform signal required by the XPR actuator driving device has not been correctly output. Therefore, there will be a period of high-voltage pulse output to the XPR actuator during startup. However, taking the requirement that the DC voltage of the XPR actuator should not exceed 1.2V as an example, if the voltage across the XPR actuator in DC voltage mode is higher than 1.2V, it will burn out the coil of the XPR actuator. The higher the DC voltage, the shorter the time required for coil burnout, and the higher the probability thereof. Similarly, not only is DC high voltage not allowed to exist at startup, but it is also not allowed to exist at any moment during the operation of the XPR actuator. For example, when the device is turned off or the DLP chip fails, causing the XPR actuator driving circuit to not output the XPR actuator driving waveform signal, but at this time, the power supplies of the XPR actuator driving circuit have not been turned off, it will still result in the output of DC high voltage, which in turn will burn out the coil of the XPR actuator.

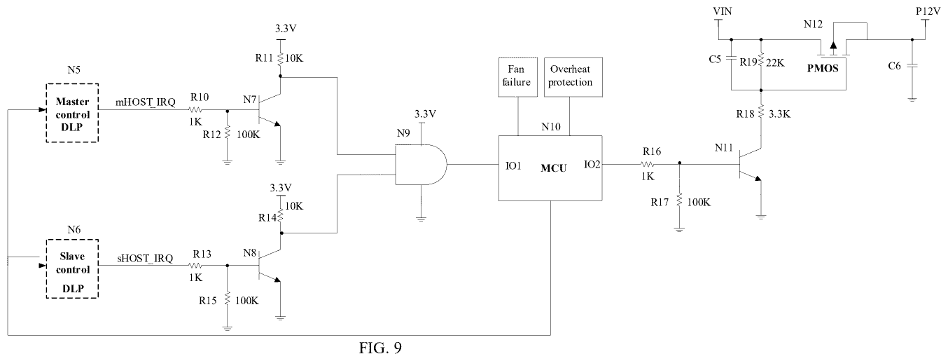

To address this issue, the embodiments of the present disclosure provide an XPR actuator driving device. FIG. 8 is a schematic structural diagram of an XPR actuator driving device according to some embodiments of the present disclosure. Referring to FIG. 8, the XPR actuator driving device includes a digital light processing (DPL) unit circuit, a delay circuit, a switch circuit, and an XPR actuator driving circuit (not shown). A portion or all of the DLP unit circuit, delay circuit, and switch circuit may be arranged in the display control assembly 10 introduced above, or may be arranged inside other components, which are not limited in the embodiments of the present disclosure. In some embodiments, the DLP unit circuit, delay circuit, and switch circuit may be circuits in the XPR actuator power supply control circuit; that is, the XPR actuator driving device includes an XPR actuator power supply control circuit and an XPR actuator driving circuit. The XPR actuator power supply control circuit includes the DLP unit circuit, delay circuit, and switch circuit.

As shown in FIG. 8, the command signal output terminal of the DLP unit circuit is connected to the input terminal of the delay circuit, and the sub-frame synchronization signal output terminal (not shown) of the DLP unit circuit is connected to the XPR actuator driving circuit. The output terminal of the delay circuit is connected to the control terminal of the switch circuit, and the input terminal of the switch circuit is connected to the power supply of the XPR actuator driving circuit. The output terminal of the switch circuit is connected to the power input terminal of the XPR actuator driving circuit, such as P12V.

The DLP unit circuit is configured to output, in the case where the DLP unit circuit is successfully configured, a configuration success command signal through the command signal output terminal and an XPR actuator sub-frame synchronization signal through the sub-frame synchronization signal output terminal. The XPR actuator sub-frame synchronization signal is used to instruct the XPR actuator driving circuit to drive the XPR actuator to deflect.

The delay circuit is configured to output, in the case where the input terminal of the delay circuit receives the configuration success command signal output by the DLP unit circuit, a turn-on signal to the control terminal of the switch circuit after a first delay (such as a preset delay).

The switch circuit is configured to establish, in the case where the control terminal of the switch circuit receives the turn-on signal, an electrical connection between the input terminal of the switch circuit and the output terminal of the switch circuit.

It can be seen that in the embodiments of the present disclosure, the DLP unit circuit can only output a configuration success command signal to the delay circuit when the configuration is successful. At this time, the DLP unit circuit also outputs an XPR actuator sub-frame synchronization signal to the XPR actuator driving circuit. After receiving the configuration success command signal, the delay circuit will output a turn-on signal to the control terminal of the switch circuit after a first delay, enabling the power supply to supply power to the XPR actuator driving circuit. By setting this delay, it can be ensured that the XPR actuator sub-frame synchronization signal is transmitted to the XPR actuator driving circuit first, and then the power supply is turned on to supply power to the XPR actuator driving circuit. This can avoid the phenomenon of the XPR actuator coil being burned due to the direct current high-voltage pulse generated by turning on the power supply before the XPR actuator sub-frame synchronization signal is transmitted to the XPR actuator driving circuit. Thus, the problem of the XPR actuator coil being prone to burnout is solved, and the reliability of the laser projection device is improved.

FIG. 9 is a circuit schematic diagram of an XPR actuator power control device according to some embodiment of the present disclosure. In some embodiments, as shown in FIG. 9, the delay circuit includes an MCU (which may be a single-chip microcomputer), denoted as N10. The command signal output terminal of the DLP unit circuit is connected to the input terminal (denoted as IO1, which may also be referred to as a detection port) of the MCU, and the output terminal (denoted as IO2) of the MCU is connected to the control terminal of the switch circuit. The MCU is configured such that when the input terminal of the MCU receives a configuration success command signal output by the DLP unit circuit, after a first delay, the output terminal of the MCU outputs an enable signal to the control terminal of the switch circuit.

In some embodiments, the MCU further includes an abnormal signal port configured to receive an abnormal signal indicating a device abnormality, such as a fan failure and/or apparatus overheat. As shown in FIG. 9, the abnormal signal port may include a fan failure signal port and an overheat signal port. The fan failure signal port is used to receive a fan failure signal, and the overheat signal port is used to receive an overheat signal, i.e., the abnormal signal includes the fan failure signal and the overheat signal. The MCU is configured such that in the case where the input terminal IO1 of the MCU receives a configuration success command signal output by the DLP unit circuit and does not receive the fan failure signals or the overheat signal, a turn-on signal is output to the control terminal of the switch circuit through the output terminal IO2 after a first delay, thereby ensuring that the MCU only outputs a turn-on signal when there are no fan, overheat, or other faults in the system.

In other embodiments, the MCU may also include a fan fault signal port without including an overheat signal; that is, the abnormal signal port includes the fan fault signal port. The MCU is configured to output, when the input terminal IO1 of the MCU receives a configuration success command signal output by the DLP unit circuit and does not receive a fan fault signal, a turn-on signal to the control terminal of the switch circuit through the output terminal IO2 after a first delay. In yet other embodiments, the MCU may also include an overheat signal port without including a fan fault port; that is, the abnormal signal port includes the overheat signal port. The MCU is configured to output, when the input terminal IO1 of the MCU receives a configuration success command signal output by the DLP unit circuit and does not receive an overheat signal, a turn-on signal to the control terminal of the switch circuit through the output terminal IO2 after a first delay.

In some embodiments, as shown in FIG. 9, the DLP unit circuit includes a master control DLP chip (denoted as N5) and a slave DLP chip (denoted as N6). The DLP unit circuit is configured to output, when both the master control DLP chip and the slave DLP chip are successfully configured, a configuration success command signal to the input terminal of the delay circuit through the command signal output terminal.

In some embodiments, as shown in FIG. 9, the DLP unit circuit further includes a first transistor (denoted as N7), a second transistor (denoted as N8), and an AND gate circuit (denoted as N9). The first transistor is configured to output a high-level configuration success command signal to one input terminal of the AND gate circuit upon receiving a low-level configuration success signal output by the master control DLP chip. The second transistor is configured to output a high-level configuration success command signal to the other input terminal of the AND gate circuit upon receiving a low-level configuration success signal output by the slave DLP chip. The AND gate circuit is configured to output a configuration success command signal to the input terminal of the delay circuit when both input terminals of the AND gate circuit receive high-level configuration success command signals. For ease of distinction, in some embodiments, the input terminals of the AND gate circuit connecting the master control DLP chip and the slave DLP chip may be referred to as the first input terminal and the second input terminal, respectively.

In one possible implementation, as shown in FIG. 9, the command signal output terminal of the master control DLP chip is connected to the base of the first transistor through resistor R10. The collector of the first transistor is connected to a 3.3V high-level power supply through resistor R11, the base of the first transistor is grounded through resistor R12, and the collector of the first transistor is also connected to the first input terminal of the AND gate. The emitter of the first transistor is grounded. The command signal output terminal of the slave DLP chip is connected to the base of the second transistor through resistor R13. The collector of the second transistor is connected to a 3.3V high-level power supply through resistor R14, the base of the second transistor is grounded through resistor R15, and the collector of the second transistor is also connected to the second input terminal of the AND gate. The emitter of the second transistor is grounded. The output terminal of the AND gate is connected to the input terminal of the MCU.

The resistance values of resistors R10, R11, R12, R13, R14, and R15 may be 1K, 10K, 100K, 1K, 10K, and 100K ohms, respectively. Of course, these resistance values are merely examples and are not intended to limit the embodiments of the present disclosure. These resistors may also have other resistance values. The level of the high-level power supply mentioned above may also be other than 3.3V, such as 3.8V, 5V, or the like, which is also not limited in the embodiments of the present disclosure.

The configuration success signals output by the master control DLP chip and the slave DLP chip are generally active low. These configuration success signals are pulled up to 3.3V high-level configuration success command signals through the first transistor and the second transistor, and then output to the MCU through the AND gate circuit, facilitating reception and identification by the MCU.

In some embodiments, the switch circuit includes a transistor. The transistor is configured to establish, when the gate of the transistor receives a turn-on signal, an electrical connection between the source and drain of the transistor.

In one possible implementation, as shown in FIG. 9, the transistor is a PMOS (denoted as N12), and the switch circuit further includes a third transistor (denoted as N11). The base of the third transistor is connected to the output terminal of the MCU through resistor R16 and is also grounded through resistor R17. The emitter of the third transistor is grounded, and the collector of the third transistor is connected to the gate of the PMOS through resistor R18. The source of the PMOS is connected to the power supply VIN, and a parallel connection of capacitor C5 and resistor R19 is connected between the gate and source of the PMOS. The drain of the PMOS is connected to the power input terminal P12V of the XPR actuator driving circuit.

When the base of the third transistor receives a high-level turn-on signal, the third transistor is turned on and grounded, the gate of the PMOS is at a low level, and the PMOS is turned on, such that the 12V system supply voltage VIN is supplied to P12V. The operational amplifier circuit N4 of the XPR actuator driving circuit is powered up with P12V, providing the driving voltage for the XPR actuator.

In the embodiments of the present disclosure, by setting the first delay, the sub-frame synchronization signal of the XPR actuator being transmitted to the XPR actuator driving circuit is ensured first, and then the power supply provides power to the XPR actuator driving circuit. This can avoid the phenomenon that a DC high-voltage pulse is generated by turning on the power supply in advance before the sub-frame synchronization signal of the XPR actuator is transmitted to the XPR actuator driving circuit, which would otherwise cause burnout of the XPR actuator coil. Accordingly, the problem that the XPR actuator coil is easily burnt out is solved, and the safety and reliability of the laser projection device are improved.

In some embodiments, the duration of the first delay may range from 20 to 500 ms, providing sufficient time for the sub-frame synchronization signal of the XPR actuator to be transmitted to the XPR actuator driving circuit, thereby ensuring the safety and reliability of the laser projection device.

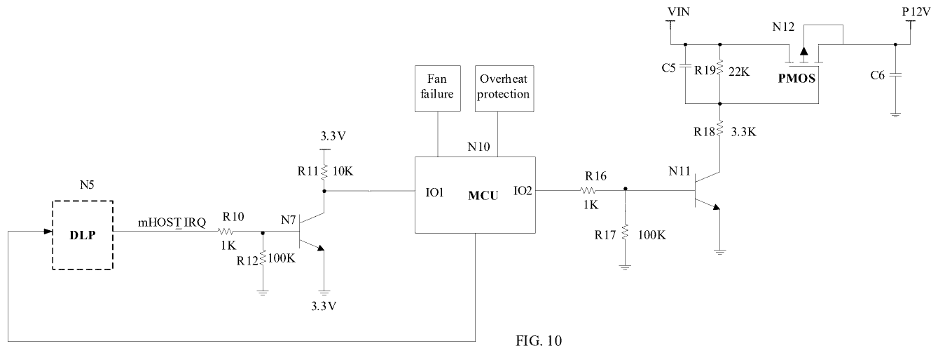

In some embodiments, as shown in FIG. 10, the DLP unit circuit may also only include one DLP chip (denoted as N5) and a first transistor (denoted as N7). The first transistor N7 is configured to output a high-level configuration success command signal to the input terminal of the delay circuit when receiving a low-level configuration success signal output by the DLP chip.

In one possible implementation, referring to FIG. 10, the command signal output terminal of the DLP chip is connected to the base of the first transistor through resistor R10. The collector of the first transistor is connected to a 3.3 V high-level power supply through resistor R11, the base of the first transistor is grounded through resistor N12, and the collector of the first transistor is also connected to the input terminal of the delay circuit. The emitter of the first transistor is grounded. The configuration success signal output by the DLP chip is generally active low, and the configuration success signal is pulled up to a 3.3V high-level configuration success command signal through the first transistor N7, facilitating the reception and recognition by the MCU.

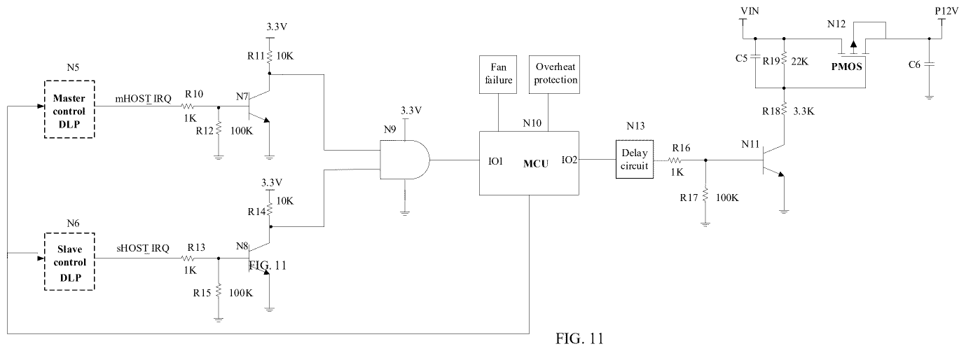

In some embodiments, as shown in FIG. 11, the MCU does not have a delay function, and a separate delay circuit (denoted as N13) is arranged between the output terminal IO2 of the MCU and the third transistor N11. After receiving the turn-on signal output by the MCU, the delay circuit N13 transmits the turn-on signal to the base of the third transistor after a first delay.

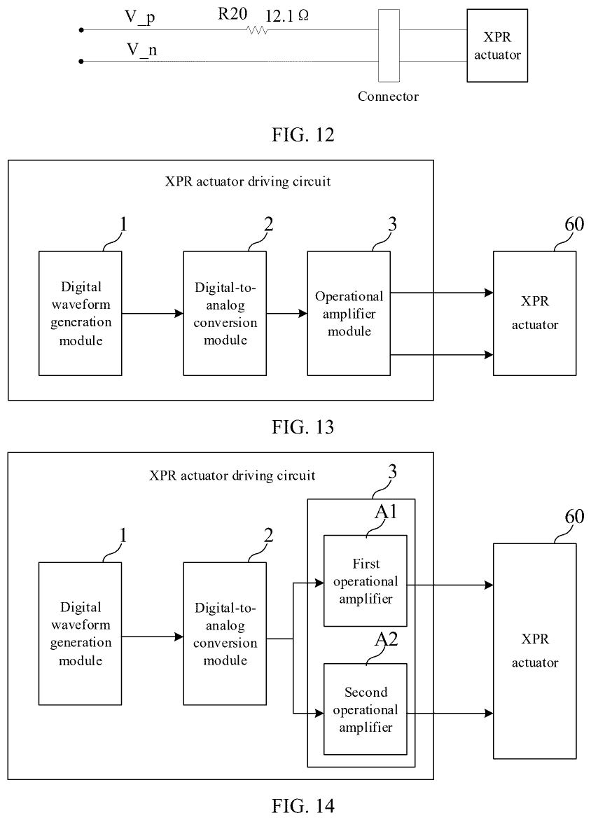

In some embodiments, as shown in FIG. 12, a voltage divider resistor R20 is connected in series between the XPR actuator driving circuit and the XPR actuator coil. The figures only illustrate the partial circuit between the output terminals V_p and V_n of the XPR actuator driving circuit and the XPR actuator. The output terminals of the XPR actuator driving circuit are connected to the XPR actuator through a connector, and the voltage divider resistor R20 is connected in series between the output terminal V_p and the connector. Here, V_p and V_n correspond to the first driving voltage and the second driving voltage, respectively.

The voltage-dividing resistor R20 is added in series to the path of the XPR actuator. The voltage-dividing resistor R20 may have the same resistance as the XPR actuator coil, or have a different resistance. The voltage-dividing resistor R20 is used to divide the voltage with the XPR actuator coil. When a high-voltage DC pulse occurs, the DC voltage applied to both ends of the XPR actuator coil is reduced, which reduces the current through the XPR actuator coil in DC mode, thereby reducing the heat generated by the XPR actuator coil and further reducing the possibility of the XPR actuator coil burnout. For example, in the case where the resistance of the XPR actuator coil is 12.1 ohms, a 12.1 ohm series resistor is added in the path of the output terminal V_p of the operational amplifier circuit to divide the voltage with the XPR actuator coil. After voltage division, the voltage applied to both ends of the XPR actuator coil is reduced to half of the original voltage, which reduces the DC voltage applied to the XPR actuator coil and decreases the heat generated by the XPR actuator coil, thus further protecting the XPR actuator coil.

In addition to the issue of coil burnout, the related art also faces the problem of high circuit cost. For example, the related art drives the XPR actuator to deflect by directly applying a driving current to the coil. However, the current driving method requires both a positive voltage generation circuit and a negative voltage generation circuit, which increases the number of components required for the circuit and thus raises the cost of the XPR actuator driving circuit. Based on this, the embodiments of the present disclosure provide an XPR actuator driving device that drives the XPR actuator to deflect by applying a driving voltage across the coil, thereby reducing the need for a negative voltage generation circuit and lowering the cost. For example, the difference between the aforementioned first driving voltage and second driving voltage is used to drive (i.e., the driving signal) the XPR actuator to deflect. In other words, the method for driving the XPR actuator to deflect using the difference between the first driving voltage and the second driving voltage mentioned above is designed by the embodiments of the present disclosure to reduce costs. This will be introduced next.

FIG. 13 is a block structural diagram of an XPR actuator driving circuit according to some embodiments of the present disclosure. As shown in FIG. 13, the XPR actuator driving circuit may include: a digital waveform generation module 1, a digital-to-analog conversion module 2, and an operational amplifier module 3. The digital waveform generation module 1 is connected to the digital-to-analog conversion module 2, and the digital waveform generation module 1 is used to generate a digital waveform signal and transmit the digital waveform signal to the digital-to-analog conversion module 2, that is, transmit the digital waveform signal to the digital-to-analog conversion module 2. The digital waveform signal includes a digital driving waveform signal. The digital-to-analog conversion module 2 is also connected to the operational amplifier module 3, and the digital-to-analog conversion module 2 is used to perform digital-to-analog conversion on the digital driving waveform signal to obtain an analog driving waveform signal, and transmit the obtained analog driving waveform signal through digital-to-analog conversion to the operational amplifier module 3, that is, transmit the analog driving waveform signal to the operational amplifier module 3. The operational amplifier module 3 is also connected to the positive terminal and the negative terminal of the coil of the XPR actuator, and the operational amplifier module 3 is used to generate a first driving voltage and a second driving voltage with opposite phases based on the analog driving waveform signal, and transmit the first driving voltage to the positive terminal of the coil and transmit the second driving voltage to the negative terminal of the coil, that is, transmit the first driving voltage to the positive terminal of the coil of the XPR actuator and transmit the second driving voltage to the negative terminal of the coil of the XPR actuator. The difference between the first driving voltage and the second driving voltage is the driving signal of the XPR actuator, and the driving signal is used to drive the XPR actuator to deflect.

In the embodiments, the digital waveform generation module 1 may include a positive voltage generation circuit, which specifically may be a waveform generator, such as an XPR actuator driving waveform generator. The digital waveform generation module 1 may be built into an FPGA. The various amplitude values corresponding to the waveform of the digital driving waveform signal may be stored in a lookup table. By setting the number of amplitude values (such as the number of target segments) for generating the digital driving waveform signal, and the number of clock cycles (the clock cycles of the digital-to-analog conversion module 2) required to output each amplitude value (such as the target segment length), the digital waveform generation module 1 can output the amplitude values of the target segment number in sequence in combination with the lookup table, thereby obtaining the digital driving waveform signal.

The digital-to-analog conversion module 2 may include a DAC converter, abbreviated as a digital-to-analog converter. The digital-to-analog conversion module 2 can convert the digital driving waveform signal transmitted by the digital waveform generation module 1 into an analog driving waveform signal. Since the operational amplifier module 3 cannot directly amplify digital signals, the digital driving waveform signal is converted into an analog driving waveform signal by the digital-to-analog conversion module 2, allowing the operational amplifier module 3 to amplify the analog driving waveform signal.

In addition, the operational amplifier module 3 may include at least one operational amplifier group, and each operational amplifier group may include two operational amplifiers. In the embodiments of the present disclosure, the operational amplifier module 3 includes one operational amplifier group, that is, two operational amplifiers are used to respectively amplify the analog driving waveform signal, obtaining a first driving voltage and a second driving voltage with opposite phases. In one possible implementation, these two operational amplifiers may be implemented by a dual operational amplifier chip. In the embodiments, since the phases of the first driving voltage and the second driving voltage are opposite, the amplitude value of the driving signal obtained by using the difference between the first driving voltage and the second driving voltage is at least twice the amplitude value of the analog driving waveform signal. In this way, a voltage driving signal with a larger amplitude value can be generated using a voltage signal with a smaller amplitude, which not only avoids burning out the operational amplifier module 3 due to the excessively large amplitude value of the analog driving waveform signal, but also improves the stability of the voltage driving.

Based on the aforementioned technical solutions, the digital waveform generation module 1 can generate corresponding digital driving waveform signals according to the actual sub-images, thereby producing driving signals of different phases to drive the XPR actuator to deflect to different positions, achieving the offset of two frames of sub-image, and thus improving the image display resolution.

The XPR actuator driving circuit provided in the embodiments of the present disclosure uses an operational amplifier module to divide an analog driving waveform signal into two, obtaining a first driving voltage and a second driving voltage with opposite phases. The first driving voltage is applied to the positive terminal of the coil of the XPR actuator, and the second driving voltage is applied to the negative terminal of the coil of the XPR actuator. The voltage driving of the XPR actuator is achieved by using the difference between the first driving voltage and the second driving voltage. In this way, the XPR actuator driving circuit provided in the embodiments of the present disclosure only requires one voltage generation circuit (corresponding to the digital waveform generation module in the embodiments of the present disclosure). The analog driving waveform signal generated by the digital waveform generation module and converted by the digital-to-analog conversion module is processed by the operational amplifier module into two driving voltages with opposite phases. The voltage driving of the XPR actuator is achieved by using the difference between the two driving voltages to drive the XPR actuator to deflect, thereby saving one voltage generation circuit and reducing the cost of the XPR actuator driving circuit.

In addition, in the related art, the XPR actuator is driven by current, and the XPR actuator is connected in series with the XPR actuator driving circuit. When the XPR actuator operates abnormally, it is impossible to determine whether the fault lies in the XPR actuator driving circuit or the XPR actuator itself by detecting the driving current. However, in the embodiments of the present disclosure, the XPR actuator is driven by voltage. When the XPR actuator operates abnormally, it is possible to determine whether the fault lies in the XPR actuator driving circuit or the XPR actuator by detecting the first driving voltage and the second driving voltage. For example, when both the first driving voltage and the second driving voltage are normal, it indicates that the XPR actuator driving circuit is operating normally, and at this time, it can be determined that the fault lies in the XPR actuator. When both the first driving voltage and the second driving voltage are abnormal, it indicates that the fault lies in the XPR actuator driving circuit. Therefore, adopting the driving method provided in the embodiments of the present disclosure is more conducive to troubleshooting.

Based on the above introduction, in some embodiments, referring to FIG. 14, the operational amplifier module 3 includes a first operational amplifier A1 and a second operational amplifier A2. The output terminal of the digital-to-analog conversion module 2 for outputting the analog driving waveform signal is connected to one input terminal of the first operational amplifier A1 and one input terminal of the second operational amplifier A2, respectively. The output terminal of the first operational amplifier A1 is connected to the positive terminal of the coil, and the output terminal of the second operational amplifier A2 is connected to the negative terminal of the coil. For ease of distinction, in some embodiments, the input terminal of the first operational amplifier A1 for receiving the analog driving waveform signal and the input terminal of the second operational amplifier A2 for receiving the analog driving waveform signal are referred to as the first input terminal and the second input terminal, respectively. It should be understood that the first terminal and the second input terminal here are not the first input terminal and the second input terminal of the AND gate circuit mentioned above.

One of the first operational amplifier A1 and the second operational amplifier A2 performs non-inverting amplification, and the other performs inverting amplification. For example, the output terminal of the digital-to-analog conversion module 2 is connected to the inverting input terminal of the first operational amplifier A1 and the non-inverting input terminal of the second operational amplifier A2, respectively. The output terminal of the first operational amplifier A1 is connected to the positive terminal of the coil, and the output terminal of the second operational amplifier A2 is connected to the negative terminal of the coil. The first operational amplifier A1 performs inverting amplification, the analog driving waveform signal is input from the inverting input terminal of the first operational amplifier A1, such that the output of the first operational amplifier A1 is inverted relative to its input. The second operational amplifier A2 performs non-inverting amplification. The analog driving waveform signal is input from the non-inverting input terminal of the second operational amplifier A2, such that the output of the second operational amplifier A2 is non-inverted relative to its input. It should be understood that one operational amplifier includes two input terminals, namely a non-inverting input terminal and an inverting input terminal. Through the connection design of the output terminal of the digital-to-analog conversion module 2 with the non-inverting and inverting input terminals of the operational amplifier, non-inverting amplification or inverting amplification can be achieved. The embodiments of the present disclosure use one non-inverting operational amplifier and one inverting operational amplifier to generate a first driving voltage and a second driving voltage with opposite phases.

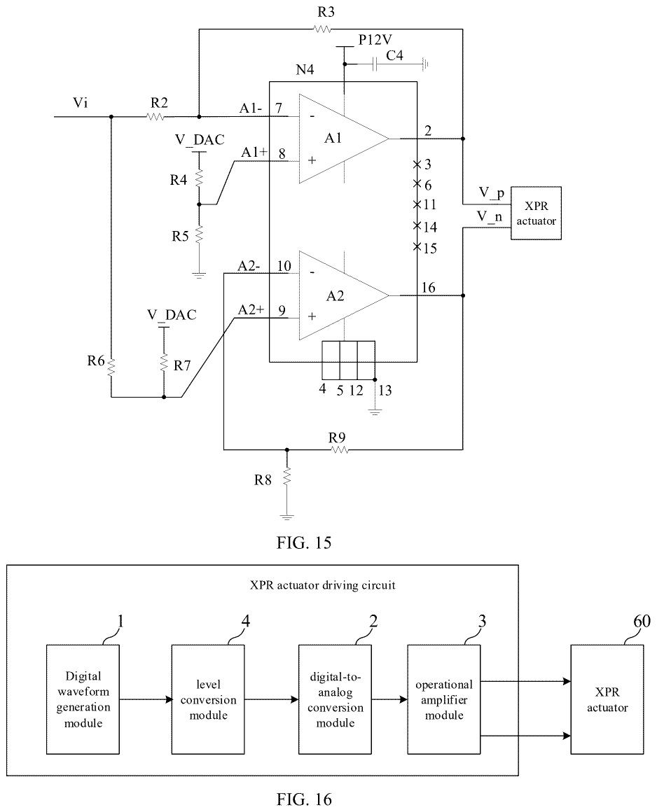

In some embodiments, the following formula for calculating the XPR actuator voltage of the circuit applies to all XPR actuators driven by this voltage. The following circuit and parameter configuration are adopted in the industry at present. As shown in FIG. 15, the first input terminal of the first operational amplifier A1 is an inverting input terminal. The operational amplifier module further includes a first resistor R2, a second resistor R3, a third resistor R4, and a fourth resistor R5. The first resistor R2 is connected to the output terminal of the digital-to-analog conversion module for outputting the analog driving waveform signal and the inverting input terminal of the first operational amplifier A1, respectively. The second resistor R3 is connected to the inverting input terminal of the first operational amplifier A1 and the output terminal of the first operational amplifier A1, respectively. The third resistor R4 and the fourth resistor R5 are connected in series between the power supply voltage V_DAC and the ground. The non-inverting input terminal of the first operational amplifier A1 is connected between the third resistor R4 and the fourth resistor R5.

The voltages at the non-inverting input terminal A1+ and the inverting input terminal A1− of operational amplifier A1 are denoted as V_A1+ and V_A1−, respectively. According to the principles of virtual short circuit and virtual open circuit of operational amplifiers, it can be obtained that:

$${V}_{A 1 +} = {V}_{A 1 -} = \frac{R 5}{R 5 + R 4} * V\_DAC \qquad ( 1 )$$

$$\frac{Vi - {V}_{A 1 -}}{R 2} = \frac{{V}_{A 1 -} - V\_p}{R 3} \qquad ( 2 )$$

From formula (2), it can be obtained that:

$$V\_p = \frac{R 3 + R 2}{R 2} * {V}_{A 1 -} - \frac{R 3}{R 2} * Vi \qquad ( 3 )$$

To substitute formula (1) into formula (3), it can be obtained that:

$$V\_p = \frac{R 3 + R 2}{R 2} * \frac{R 5}{R 5 + R 4} * V\_DAC - \frac{R 3}{R 2} * Vi \qquad ( 4 )$$

Therefore, the analog driving waveform signal Vi is subjected to inverting amplification by the first operational amplifier A1, so as to obtain the first driving voltage V_p.

In some embodiments, referring to FIG. 15, the second input terminal of the second operational amplifier A2 is a non-inverting input terminal. The operational amplifier module further includes a fifth resistor R6, a sixth resistor R7, a seventh resistor R8, and an eighth resistor R9. The fifth resistor R6 is connected to the output terminal of the digital-to-analog conversion module for outputting the analog driving waveform signal and the non-inverting input terminal of the second operational amplifier A2, respectively. The sixth resistor R7 is connected to the power supply voltage V_DAC and the non-inverting input terminal of the second operational amplifier A2, respectively. The seventh resistor R8 and the eighth resistor R9 are connected in series between the output terminal of the second operational amplifier A2 and the ground. The inverting input terminal of the second operational amplifier A2 is connected between the seventh resistor R8 and the eighth resistor R9.

According to the principles of virtual short circuit and virtual open circuit of operational amplifier, it can be obtained that:

$${V}_{A 2 +} = {V}_{A 2 -} \qquad ( 5 )$$

$${V}_{A 2 -} = \frac{R 8}{R 8 + R 9} * V\_n \qquad ( 6 )$$

$${V}_{A 2 +} = \frac{R 6}{R 6 + R 7} * V\_DAC - \frac{R 7}{R 6 + R 7} * Vi \qquad ( 7 )$$

To substitute formula (7) into formula (6), it can be obtained that:

$$V\_n = \frac{R 8 + R 9}{R 8} ( \frac{R 6}{R 6 + R 7} * V\_DAC + \frac{R 7}{R 6 + R 7} * Vi ) \qquad ( 8 )$$

Therefore, the analog driving waveform signal Vi is subjected to non-inverting amplification by the second operational amplifier A2, so as to obtain the second driving voltage V_n.

Based on formulas (4) and (8), we can derive the formula for the driving signal:

$$V\_p - V\_n = ( \frac{R 3 + R 2}{R 2} * \frac{R 5}{R 5 + R 4} ) * V\_DAC - ( \frac{R 3}{R 2} + \frac{R 8 + R 9}{R 8} * \frac{R 7}{R 6 + R 7} ) * Vi \qquad ( 9 )$$

Therefore, based on the aforementioned formula (9), various parameters such as resistors may be configured according to the actual needs of the XPR actuator, converting the digital driving waveform signal output by the digital-to-analog conversion module into an amplified driving signal that can drive the XPR actuator, thus achieving XPR actuator deflection.

Referring to FIG. 15, the aforementioned first operational amplifier A1 and second operational amplifier may be implemented by a dual operational amplifier circuit N4. The dual operational amplifier circuit N4 has a plurality of pins, including pins 1 to 16. The pins 7, 8, and 2 serve as the inverting input terminal, non-inverting input terminal, and output terminal of the first operational amplifier A1, respectively. The pins 10, 9, and 16 serve as the inverting input terminal, non-inverting input terminal, and output terminal of the second operational amplifier A2, respectively. Pin 1 is connected to the power supply terminal P12V, and the pins 4, 5, 12, and 13 are grounded. The remaining pins are not used in the embodiments of the present disclosure.

In some embodiments, the digital waveform signal further includes a waveform output clock signal and a waveform output enable signal. The waveform output clock signal is used to provide a control clock for generating the digital driving waveform signal and the analog driving waveform signal, and the waveform output enable signal is used to instruct the digital-to-analog conversion module to perform digital-to-analog conversion on the digital driving waveform signal and output the analog driving waveform signal.

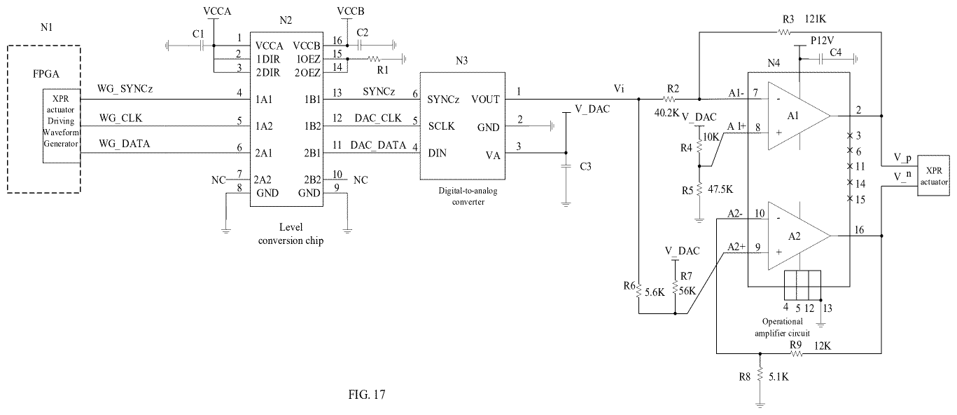

In some embodiments, referring to FIGS. 16 and 17, the XPR actuator driving circuit further includes a level conversion module 4 (represented as a level conversion chip in FIG. 17); the level conversion module 4 can perform logic level conversion based on VCCA and VCCB, such as converting a digital waveform signal with a logic level equal to VCCB to obtain a digital waveform signal with a logic level equal to VCCB. That is, the level conversion module 4 is connected to the digital waveform generation module 1 and the digital-to-analog conversion module 2, respectively, and is used to convert the logic level of the digital waveform signal to a logic level that matches the operating level of the digital-to-analog conversion module 2, thereby enabling the digital-to-analog conversion module 2 to operate normally and achieving the conversion of the digital driving waveform signal by the digital-to-analog conversion module 2.

For example, the waveform output clock signal (referred to as clock signal) WG_CLK and the waveform output enable signal (also known as synchronization signal) WG_SYNCz are at a 1.8V level, and the amplitude level (i.e., logic level) of the digital driving waveform signal (also known as driving waveform data) WG_DATA is 1.8V. However, the operating level of the digital-to-analog conversion module 2 is 3.3V. In this case, it is necessary to convert the logic level of the aforementioned digital waveform signal to 3.3V through the level conversion module 4, and then transmit the converted digital waveform signal to the digital-to-analog conversion module 2. The converted digital waveform signal includes the digital driving waveform signal DAC_DATA, the waveform output clock signal DAC_CLK, and the waveform output enable signal SYNCz.

Based on the above embodiments, the embodiments of the present disclosure disclose the first driving voltage, the second driving voltage, and the driving signal by configuring the parameters of circuit components. In some embodiments, referring to FIGS. 17, C1, C2, C3, and C4 are all 100 nF, R1=100K, R2=40.2K, R3=121K, R4=10K, R5=47.5K, R6=5.6K, R7=56K, R8=5.1K, R9=12K, and the V_DAC voltage is 3.3V. C1, C2, C3, and C4 may be filter capacitors. To substitute the above parameters into formulas (4) and (7), formulas (10) and (11) may be obtained.

$$V\_p = 10.9 - 3 Vi \qquad ( 10 )$$

$$V\_n = 1 + \text{.305} Vi \qquad ( 11 )$$

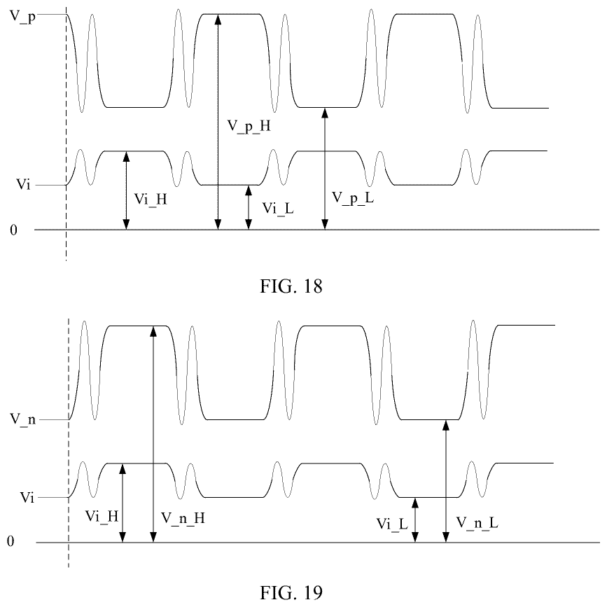

Referring to FIG. 18, Vi is a waveform with a maximum amplitude level of 3.3V, which is input to the inverting input terminal A1—of the first operational amplifier A1. The output waveform is invertingly amplified and output. The amplification relationship between the output waveform and the input waveform of the first operational amplifier A1 corresponds to formula (8). The output voltage waveform V_p of the first operational amplifier A1 is the input waveform inverted and amplified. The actual output waveform Vi_L has a voltage of approximately 1.3V, and the corresponding output waveform V_p_H has a voltage of approximately 7V. Vi_H has a voltage of approximately 1.96V, and the corresponding output waveform V_p_L has a voltage of approximately 5V. The waveform after amplification, with the difference between peak and trough values, is approximately three times that of the input waveform. The actual input and output waveforms correspond one-to-one with the formula relationship, which is consistent.

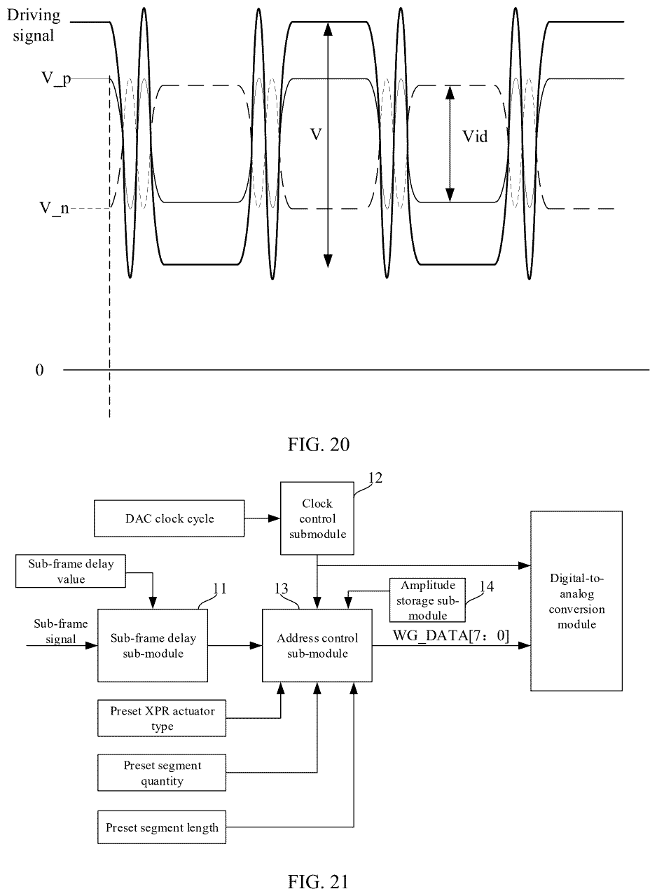

Vi is also input to the non-inverting input terminal A2+ of the second operational amplifier A2. The input waveform Vi is the same as the input waveform to the first operational amplifier A1, and the output waveform is amplified in phase, resulting in a waveform with the same phase. The amplification relationship between the output waveform and the input waveform of the second operational amplifier A2 corresponds to formula (9). Referring to FIG. 19, the actual output waveform Vi_L has a voltage of approximately 1.3V, corresponding to a V_n_L voltage of approximately 4.965V. The Vi_H voltage is approximately 1.96V, corresponding to a V_n_H voltage of approximately 6.978V. The actual input and output waveforms correspond one-to-one with the formula relationship. This verifies that the maximum and minimum amplitude values of the V_p and V_n waveforms are approximately the same, indicating correct parameter configuration and that they are the desired driving waveforms. The voltage applied to both ends of the XPR actuator is the difference between the output waveform V_p of the first operational amplifier A1 and the output waveform V_n of the second operational amplifier A2, as shown in FIG. 20. The waveform with the highest amplitude value is the final voltage signal waveform of the XPR actuator, and the amplitude value V is twice the input amplitude value Vid. The XPR actuator moves under the driving of the voltage driving waveform, and the voltage level for driving the XPR actuator is relatively high (e.g., the peak high-level portion reaches 8V), thereby improving driving stability.

The XPR actuator driving circuit provided in the embodiments of the present disclosure may be applied to the XPR actuator driving device (including DLP chip) in the related art, and may also be applied to the XPR actuator driving device provided in the embodiments of the present disclosure, such as the XPR actuator driving device shown in FIGS. 8 to 12. However, it should be understood that if the XPR actuator driving circuit provided in the embodiments of the present disclosure is applied to the XPR actuator driving device in the related art, there is still a problem that the coil is prone to burnout. Next, this will be introduced in conjunction with the XPR actuator driving circuit shown in FIG. 17.

The embodiments of the present disclosure are described with an example of driving the XPR actuator with two-dimensional voltages (i.e., a first driving voltage and a second driving voltage). The XPR actuator driving circuit is shown in FIG. 17, including a digital waveform generation module (which may be a video image processing chip N1), a level conversion module (which may be a level conversion chip N2), a digital-to-analog conversion module (which may be a digital-to-analog converter N3), an operational amplifier module (which may be an operational amplifier circuit N4, including an operational amplifier A1 and an operational amplifier A2), and the like.

The video image processing chip N1 of the laser projection device may be implemented using a field programmable gate array (FPGA) or other methods. After receiving the sub-frame synchronization signal from the DLP chip (included in the DLP unit circuit), N1 outputs the synchronization signal WG_SYNCz, clock signal WG_CLK, and driving waveform data WG_DATA of the XPR actuator. This driving waveform data is converted from VCCA (1.8V) to VCCB (3.3V) by the level conversion chip N2. After conversion, the digital-to-analog converter N3 at the back end can recognize and match the level, and outputs the synchronization signal SYNCz, clock signal DAC_CLK, and driving waveform data DAC_DATA to the digital-to-analog converter N3. The driving waveform data is converted from digital to analog Vi by the digital-to-analog converter N3 and output to the operational amplifier circuit N4. The analog driving waveform Vi is simultaneously input to two operational amplifiers A1 and A2 in N4. On the one hand, the analog driving waveform Vi is input to the inverting input terminal of operational amplifier A1, and after amplification by operational amplifier A1, a voltage waveform V_p is output, which serves as the positive terminal voltage of the XPR actuator, that is, applied to the positive terminal of the XPR actuator coil. On the other hand, the analog driving waveform Vi is input to the non-inverting input terminal of operational amplifier A2, and after amplification by operational amplifier A2, the negative terminal voltage V_n of the XPR actuator is output, that is, applied to the negative terminal of the XPR actuator coil. Therefore, the driving voltage across the two ends of the XPR actuator is V_p-V_n. Under normal operation, the XPR actuator moves under the driving of the analog driving voltage waveform of V_p-V_n, that is, it deflects.

The normal driving circuit is designed such that when the FPGA outputs the driving waveform data of the XPR actuator, the power supplies VCCA and VCCB for N2, V_DAC for N3, P12V for N4, the voltage divider resistor supply V_DAC for the inverting terminal of the operational amplifier A1, and the pull-up resistor supply V_DAC for the operational amplifier A2 are all powered up immediately at startup. At this time, the XPR actuator driving waveform data sent by the FPGA has not been output correctly, so there will be a period of high-voltage pulse output to the XPR actuator during startup. However, the specification of the XPR actuator requires that the DC voltage should not exceed 1.2V. In DC voltage mode, a voltage higher than 1.2V across the XPR actuator terminals may burn out the coil of the XPR actuator. The higher the DC voltage, the shorter the time it takes to burn out the coil, and the higher the probability. Similarly, DC high voltage shall not be present not only during power-on, but also at any moment when the XPR actuator is operating. For example, when the XPR actuator is turned off or when a DLP failure causes the FPGA not to output the XPR actuator driving waveform data, but the power supplies of the XPR actuator driving circuit are not turned off, it will still result in the output of DC high voltage, which may cause the coil of the XPR actuator to burn out.

The specific reasons for generating DC high voltage include startup, shutdown, or malfunction, which lead to situations where the video image processing chip N1 has not yet output the driving waveform data WG_SYNCz, WG_CLK, and WG_DATA. However, the power supply terminals of the chips in the XPR actuator driving circuit are continuously powered. Under these circumstances, the chips in the XPR actuator driving circuit operate normally, but there is no output of XPR actuator driving waveform data. Therefore, the output Vi of the digital-to-analog converter N3 is absent, equivalent to a disconnected state.

N4 includes two operational amplifiers A1 and A2, as shown in FIG. 17. The configuration resistors and corresponding resistance values of the operational amplifiers are indicated in the circuit schematic diagram. According to the operating principle of the operational amplifiers and in combination with formulas (1) to (9), amplitude values of the two outputs V_p and V_n of the two operational amplifiers can be calculated. By substituting the resistance parameters of R4 and R5 into formula (1), such that V_{A1+}=47.5/(47.5+10)×3.3=2.726 V. According to the principles of virtual short circuit and virtual open circuit, V_{A1-}=V_{A1+}=2.726V, and the currents flowing through R2 and R3 are the same. Substituting the resistance values of R2, R6, R7, and the voltage values of V_DAC and V_{A1-} into formula (2), I_{R3}=(3.3−2.726)/(56+5.6+40.2)=5.639×10⁻⁶ A is obtained from the relationship between voltage, resistance, and current. The voltage drop across resistor R3 is V__{R3}=I_{R3}λR3=5.639×10⁻⁶×121×10³=0.682V. The output voltage of the operational amplifier A1 is V_p=V_{A1-}−V_{R3}=2.726−0.682=2.044V.

The non-inverting terminal input voltage of the operational amplifier A2: V_{A2+}=V_DAC−I_{R3}×R7=3.3−5.639×10⁻⁶×56×10³=2.984V. The inverting input terminal voltage of the operational amplifier A2: V_{A2-}=V_{A2+}=2.984V. The output voltage of the operational amplifier A2: V_n=(R8+R9)/R8×V_{A2-}=(5.1+12)/5.1×2.984=10.005V.

Therefore, when the XPR actuator driving waveform data has not been output, the operational amplifier is operational and will output a DC voltage. The voltage applied across the XPR actuator terminals is V_p−V_n=10.005−2.044=7.961V. However, the coil resistance of the XPR actuator is generally only 12.1 ohms. Therefore, the coil of the XPR actuator generates heat under a high current of approximately 0.7 A, eventually damaging the fixing adhesive of the coil. The melting of the fixing adhesive causes coil collapse, resulting in the failure of the XPR actuator.

The embodiments of the present disclosure provide an XPR actuator driving circuit applied to a laser projection device, which can protect the XPR actuator coil and avoid the XPR actuator coil burnout. In the XPR actuator driving circuit shown in FIG. 17, the output of direct current (DC) high-voltage pulses is avoided. That is, when the input voltage V_DAC of the operational amplifier circuit N4 and the power supply P12V are powered on, it is ensured that the driving waveform data of the XPR actuator is output, and the situation where the operational amplifier is working but the driving waveform Vi is not output is not allowed.

Combined with FIG. 9 and FIG. 17, the working process of the laser projection device provided in the embodiments of the present disclosure is as follows:

After power-on, the master control DLP chip and the slave DLP chip of the laser projection device first perform initialization configuration. In the case where the configuration is successful and there is no fault interruption, a configuration success signal is output. The configuration success signal includes mHOST_IRQ (output by the master control DLP chip) and sHOST_IRQ (output by the slave DLP chip) as shown in FIG. 9.

mHOST_IRQ and sHOST_IRQ are signals with a voltage level of 1.8V, which are active low. These signals are pulled up to a voltage level of 3.3V through the collectors of the first N-type transistor N7 and the second N-type transistor N8. Therefore, the low voltage levels of the mHOST_IRQ and sHOST_IRQ signals, which are output after the master control chip and the slave control chip have successfully completed the boot initialization configuration through the first N-type transistor N7 and the second N-type transistor N8, are converted to high voltage levels of 3.3V, which are active high. The two high voltage level outputs pass through the AND gate circuit N9 and output a high voltage level configuration success command signal to the MCU. That is, both mHOST_IRQ and sHOST_IRQ are output simultaneously, and only after passing through the AND gate circuit can they become high voltage levels. As long as one of the control chips is not successfully configured or both are not successfully configured, the system will not start. The system can only start normally if both the master DLP chip and the slave DLP chip are successfully configured. Otherwise, the system will not start.

When the input terminal IO1 of the MCU acquires a high-level signal and no system error, fan fault error, or overheat error occurs, the MCU will delay for a period of time and then output a high-level turn-on signal through the output terminal IO2. Under the control of this high-level turn-on signal, the third transistor N11 is turned on to ground, the gate of the PMOS N12 is at a low level, and the PMOS is turned on, inputting the system with a 12V power supply VIN to P12V. The XPR actuator driving circuit starts to work; for example, the operational amplifier in the XPR actuator driving circuit is powered on by the P12V supply and starts to work.

During the aforementioned first delay time, when a high voltage level is detected at the input terminal IO1 of the MCU, the master control DLP chip sends a synchronization signal for the XPR actuator driving waveform output to FPGA N1, as shown in FIG. 17. Under the control of this synchronization signal, the FPGA begins to output the XPR actuator driving waveform data. This data passes through the level conversion circuit N2 and the digital-to-analog converter N3, and precedes the power-on time of the supply P12V from the operational amplifier circuit N4. Therefore, it does not output a direct current (DC) high-voltage pulse to the XPR actuator coil. When the output terminal IO2 of the MCU is not outputting, the base of N11 is pulled low through resistor R17, making N11 non-conductive. The gate of N12 is at a high voltage level, so N12 is also non-conductive. As a result, there is no voltage output from P12V, and N4 does not operate, thus no DC high-voltage pulse is output.

When an error or fault occurs in the DLP system, either or both of mHOST_IRQ and sHOST_IRQ will be pulled high, and either or both of N7 and N8 will be turned on. As a result, one or both of the input terminals of the AND gate N9 will be at a low level, causing the output of N9 to be low. At this time, the input terminal IO1 of the MCU acquires a low level, and the output terminal IO2 of the MCU outputs low, turning off the power supply of P12V to the operational amplifier circuit N4. In the event of system failure, the driving waveform data output by the FPGA is disabled after the master control DLP chip or slave DLP chip stops working, which is later than the disconnection of the P12V power supply to N4.

In the case of a complete malfunction of the laser projection device, such as fan failure or overheat fault, or during a normal shutdown, the power supply to the P12V of the XPR actuator operational amplifier circuit N4 is first shut down in the shutdown sequence control, thereby turning off the XPR actuator. Subsequently, a shutdown command is sent to shut down the DLP chip. Therefore, in any case of a shutdown command, such as fan failure, overheat fault, or normal shutdown, the output terminal IO2 of the MCU will output a low voltage level, shut down the power supply to the P12V of the XPR actuator operational amplifier circuit N4, and turn off the XPR actuator, thus avoiding the problem of the XPR actuator being burned by the DC high-voltage pulse generated by the output of non-driving waveform data.

In the embodiments of the present disclosure, the DC high-voltage pulse is eliminated by altering the timing between the output of XPR actuator driving waveform data WG_SYNCz, WG_CLK, and WG_DATA, and the power supply P12V of the operational amplifier circuit N4.

The power-on sequence in the embodiments of the present disclosure is as follows: first, the XPR actuator driving waveform data WG_SYNCz, WG_CLK, and WG_DATA are output; then, the power supply V_DAC for the digital-to-analog converter N3 is output; subsequently, the power supply P12V for the operational amplifier circuit N4 is output, or both the power supply V_DAC for the digital-to-analog converter N3 and the power supply P12V for the operational amplifier circuit N4 are output simultaneously.

The power-down sequence in the embodiments of the present disclosure is as follows: in the case of a fault or shutdown during product operation, first shut off the power supply P12V to the operational amplifier circuit N4, then shut off the power supply V_DAC to the digital-to-analog converter N3, and finally shut off the XPR actuator driving waveform data. Alternatively, both the power supply V_DAC to the digital-to-analog converter N3 and the power supply P12V to the operational amplifier circuit N4 can be shut off simultaneously. As shown in FIG. 17, P12V is the power supply for the operational amplifier circuit N4. When the power supply P12V to the operational amplifier circuit N4 is shut off first, the operational amplifier circuit N4 will not operate, resulting in no output voltage. Therefore, even if the power supply V_DAC to the digital-to-analog converter N3 and the XPR actuator driving waveform are not shut off, no DC high-voltage pulse will occur, and the XPR actuator coil will not be burned.

The power supply P12V of the operational amplifier circuit N4 directly controls whether N4 operates, meaning that the power supply P12V is the key to determining whether a DC high-voltage pulse is output. Therefore, the key to eliminating the DC high-voltage pulse lies in controlling the timing of the power supply P12V of the operational amplifier circuit N4. The optimal timing control of the power-on and power-off sequences is to control the power supply P12V of the operational amplifier circuit N4. To solve the problem of the XPR actuator coil burnout, the embodiments of the present disclosure add the XPR actuator power control circuit shown in FIG. 9 to the XPR actuator driving circuit shown in FIG. 17, controlling the power-on and power-off sequences of the power supply P12V for the operational amplifier N4 in FIG. 17, thereby eliminating the DC high-voltage pulse driving the XPR actuator.

In addition to solving the problem of the XPR actuator coil burnout and reducing circuit costs, the embodiments of the present disclosure further enable the design of the generation method of digital driving waveform signals, such that the XPR actuator can move to the precise position required for sub-image display, ensuring correct projection. This will be introduced next.

The embodiments of the present disclosure also provide a digital waveform generation module. FIG. 21 is a schematic structural diagram of a digital waveform generation module according to some embodiments of the present disclosure. This digital waveform generation module can be used as the digital waveform generation module shown in FIG. 13, FIG. 14, FIG. 16, and FIG. 17 in the above embodiments.

As shown in FIG. 21, the digital waveform generation module may include: a sub-frame delay sub-module 11, a clock control sub-module 12, an address control sub-module 13, and an amplitude storage sub-module 14. The sub-frame delay sub-module 11 is connected to the address control sub-module 13, and is used for delaying the sub-frame signal to obtain a delayed sub-frame signal, and transmitting the delayed sub-frame signal to the address control sub-module 13, that is, transmitting the delayed sub-frame signal to the address control sub-module 13. The sub-frame signal is a sub-frame signal of two frames of sub-image obtained by decomposing one frame of image, and the delayed sub-frame signal is used to synchronize or align the display of the sub-images with the movement of the XPR actuator. The clock control sub-module 12 is connected to the address control sub-module 13, and is used for providing the address control sub-module 13 with a control clock for generating a digital driving waveform signal (which may be referred to simply as a digital driving waveform). The amplitude storage sub-module 14 is connected to the address control sub-module 13, and is used for storing a plurality of amplitude values of the digital driving waveform signal, which may be stored in a certain storage order, such as a preset storage order; the address control sub-module 13 is used for, in response to the delayed sub-frame signal, reading the plurality of amplitude values (the total number of which is a target number segment) from the amplitude storage sub-module 14 according to the target XPR actuator type when the edge of the delayed sub-frame signal arrives, and outputting the plurality of amplitude values in the reading order to generate the digital driving waveform signal. The first to the second last amplitude value read are continuously output with a target segment length, and the last amplitude read is continuously output until the next edge of the delayed sub-frame signal arrives. The target XPR actuator type indicates the reading method of the amplitude values, the target number segment indicates the number of amplitude values stored in the amplitude storage sub-module 14, and the target segment length indicates the clock length of the plurality of control clocks.

The previous edge of the delayed sub-frame signal may be either a rising edge or a falling edge, and the next edge of the delayed sub-frame signal may be either a falling edge or a rising edge, meaning that the two adjacent edges are opposite.

Referring to FIG. 21, the target XPR actuator type may be a preset XPR actuator type, which may include a plurality of types of XPR actuators. The target segment number may be a preset segment number, such as 256 or 512. The target segment length may be a preset segment length, such as the clock length of two control clocks, or the clock length of four, six, eight, or other numbers of control clocks.

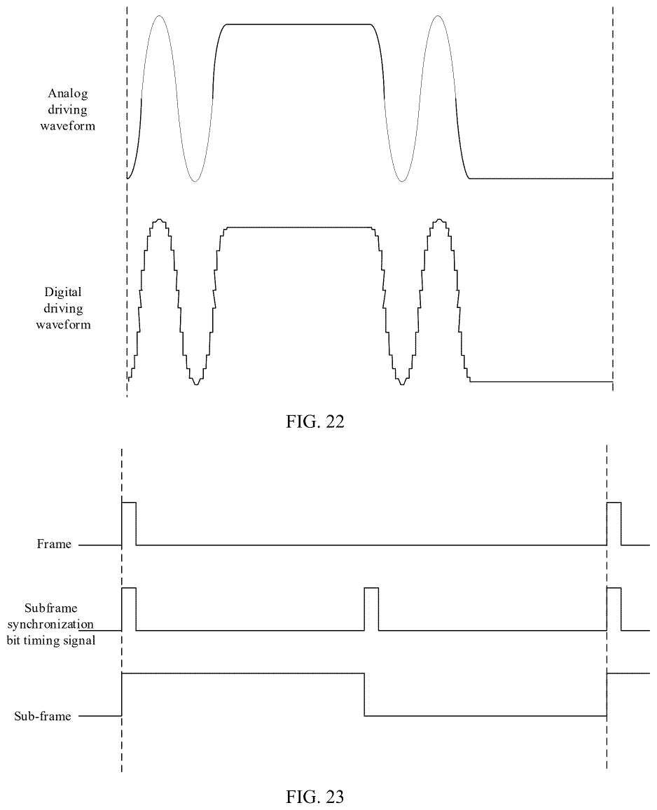

In the embodiments of the present disclosure, referring to FIG. 22, according to the desired waveform required for driving the XPR actuator, i.e., the simulated driving waveform, in the digital circuit, it is necessary to convert the simulated driving waveform into a digital driving waveform, using the digital driving waveform to approximately simulate the driving waveform. That is, the simulated driving waveform may be estimated and implemented by many equally long segments, forming an editable digital driving waveform. The amplitude value and the number of amplitude values of the digital driving waveform may be edited. To this end, each amplitude value of the digital driving waveform to be generated may be stored in the amplitude storage sub-module 14 according to a preset storage order, where the preset storage order may be the sequential order of the amplitude values of the digital driving waveform. Illustratively, each amplitude value may be an 8-bit unsigned number, and the amplitude storage sub-module 14 may include a 256×8 memory, i.e., it may store 256 8-bit unsigned amplitude values, and each amplitude value may be stored in the form of a lookup table. In order to adapt to the two positions of the XPR actuator movement, one frame of image is divided into two sub-frame images (i.e., two frames of sub-image in the embodiments of the present disclosure), and correspondingly, each sub-frame image corresponds to one position of the XPR actuator movement. Referring to FIG. 23, the display control assembly decomposes one frame of image into two sub-frame images and triggers the output of the sub-frame signal through the sub-frame synchronization bit timing signal. In the embodiments of the present disclosure, in order to ensure that the generated digital driving waveform is synchronized with the display of sub-images and the movement of the XPR actuator when driven by the XPR actuator driving assembly, the sub-frame signal is delayed by the sub-frame delay sub-module 11 to generate the delayed sub-frame signals, which are transmitted to the address control sub-module 13. When the rising edge or falling edge of the delayed sub-frame signal arrives, the address control sub-module 13 outputs a plurality of amplitude values from the amplitude storage sub-module 14 in sequence according to the target segment length, thereby generating a digital driving waveform.

In one possible implementation, the sub-frame delay sub-module 11 may delay the sub-frame signal according to the set sub-frame delay value. Illustratively, the sub-frame delay value is a programmable value, such as a certain number of system clocks. After inputting the sub-frame signal into the digital waveform generation module of the XPR actuator, the time for obtaining the delayed sub-frame signal input to the address control sub-module 13 from the sequencer is first determined, and the clock used for sub-frame delay is obtained based on the system clock. When the system clock uses a 24 MHz crystal oscillator, the system clock period is 41.667 ns, and the clock used for sub-frame delay is the system clock, such as 24 MHz, rather than the programmable DAC clock used to drive various functions of waveform generation. The clock control sub-module 12 provides the control clock for generating digital driving waveform signals to the address control sub-module 13, referred to as the DAC clock. At the same time, the clock control sub-module 12 is also connected to the digital-to-analog conversion module of the laser projection device (either directly or through a level conversion module). The clock control sub-module 12 is also used to transmit the control clock to the digital-to-analog conversion module, providing the clock for data input to the digital-to-analog conversion module. When the system clock is 24 MHz, the range of the DAC clock is from 2 to 16 system clocks. For example, the relationship between the DAC clock and the system clock is that the DAC clock is a system clock with a step size of 2, that is, the DAC clock ranges from 83.33 ns to 666.67 ns. This DAC clock is used to drive various functions of waveform generation and is input into the backend digital-to-analog conversion module as the clock for data input to the digital-to-analog conversion module, which is the digital waveform output clock WG_CLK.

The present disclosure embodiment provides two reading methods for reading the amplitude value characteristic of a target XPR actuator type.

The first reading method is a forward sequence followed by a reverse sequence. Specifically, after the rising edge of the delayed sub-frame signal arrives, the first amplitude value of the amplitude storage sub-module 14 is output and continuously output for the number of DAC clocks specified by the target segment length. Subsequently, the second amplitude value is output in the same manner for the number of DAC clocks specified by the target segment length, and so on, until the number of output amplitude values reaches the target segment quantity. The last amplitude value is continuously output until the falling edge of the delayed sub-frame signal arrives. After the falling edge of the delayed sub-frame signal arrives, the last amplitude value of the amplitude storage sub-module 14 is output first. The output manner is consistent with that at the rising edge, except that the amplitude values are read from the amplitude storage sub-module 14 in a reverse sequence, that is, the amplitude values are output in reverse order. That is, after the falling edge of the delayed sub-frame signal arrives, the last stored amplitude value is output first, and the last amplitude value is output for the number of DAC clocks specified by the target segment length. Then, the second-to-last amplitude value of the amplitude storage sub-module 14 is output, also for the number of DAC clocks specified by the target segment length, and so on, until the number of output amplitude values reaches the target segment quantity. It can be seen that the output sequence of amplitude values corresponding to two adjacent sub-frames is reversed.

The second reading method adopts a forward sequence followed by a forward sequence inversion (complement or complementary value). Specifically, during the forward sequence reading process, the first stored amplitude value is continuously output for the number of DAC clocks specified by the target segment length. Subsequently, the second amplitude value is output for the same number of DAC clocks specified by the target segment length, and so on, until the number of output amplitude values reaches the preset segment quantity. The last amplitude value is continuously output until the falling edge of the delayed sub-frame signal arrives. After the falling edge of the delayed sub-frame signal arrives, the first amplitude value of the amplitude storage sub-module 14 is inverted and then output. The inversion means that the amplitude values in the amplitude storage sub-module 14 are extracted in the form of a complement (complementary value), and the reading order of these inverted amplitude values remains the same as that at the rising edge, still starting from the first amplitude value in the amplitude storage sub-module 14.

The number of target segments is the number of amplitude values used to generate the digital driving waveform, and also the number of amplitude values stored in the amplitude storage sub-module 14. In some embodiments, the setting range of the number of target segments may be from 2 to 255. The length of the target segment is the clock length of each amplitude value; that is, one amplitude value maintains a plurality of DAC clock outputs. The setting range of the target segment length may be from 2 to 65535 DAC clocks. It can be understood that the number of target segments and the length of the target segment jointly determine the similarity between the digital driving waveform signal and the analog driving waveform signal. For example, the more target segments there are and the shorter the length of each target segment is, the higher the similarity between the digital driving waveform signal and the analog driving waveform signal.

The aforementioned address control sub-module 13 has a plurality of address bits, which respectively store numerical values representing the target XPR actuator type, target segment quantity, target segment length, and the addresses of the amplitude values stored in the amplitude storage sub-module 14. In this way, by setting the target XPR actuator type, the target segment quantity, and the target segment length, address control of the digital driving waveform is formed under the trigger of the control clock.

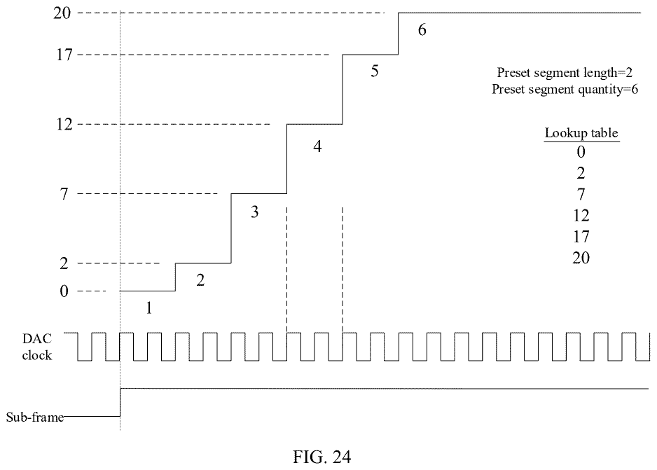

Based on the aforementioned technical solution, in a specific embodiment of data-driven waveform generation, as shown in FIG. 24, after the arrival of the rising edge or falling edge of the sub-frame signal, amplitude values (the amplitude storage sub-module 14) in the lookup table are started to output under the trigger of the DAC clock (control clock). The first amplitude value output is 0. After two DAC clock cycles, the second amplitude value is output, which is 2. After another two DAC clock cycles, the third amplitude value is output, which is 7. Similarly, the fourth and fifth amplitude values, 12 and 17, are output in sequence every two clock cycles. After two clock cycles, the last amplitude value in the lookup table, 20, is output, and this amplitude value 20 is maintained until the arrival of the falling edge or rising edge of the delayed sub-frame signal. Then, the amplitude values in the lookup table are output in a certain order (such as reverse sequence or forward sequence inversion).

From the above example, it can be seen that there are 6 amplitude values in the lookup table, which are 0, 2, 7, 12, 17, and 20, indicating that the generated waveform has 6 amplitude values, i.e., the preset segment number is equal to 6. Each of these 6 amplitude values maintains an output length of at least 2 DAC clock lengths, meaning that the same amplitude value is output continuously for 2 DAC clock cycles, i.e., the preset segment length is equal to 2. Therefore, by setting the target segment number required for the digital driving waveform, the lookup table includes the waveform amplitude values generated for each segment of the digital driving waveform corresponding to the set target segment number. The number of DAC clocks required for waveform output is determined based on the set target segment length. The target segment length is used as the time period to output the target segment number of amplitude values in the lookup table in sequence. When outputting the last amplitude value, it is continuously output until the edge of the delay sub-frame signal arrives, and then the amplitude values in the lookup table are output in a certain manner. This generates the digital driving waveform.

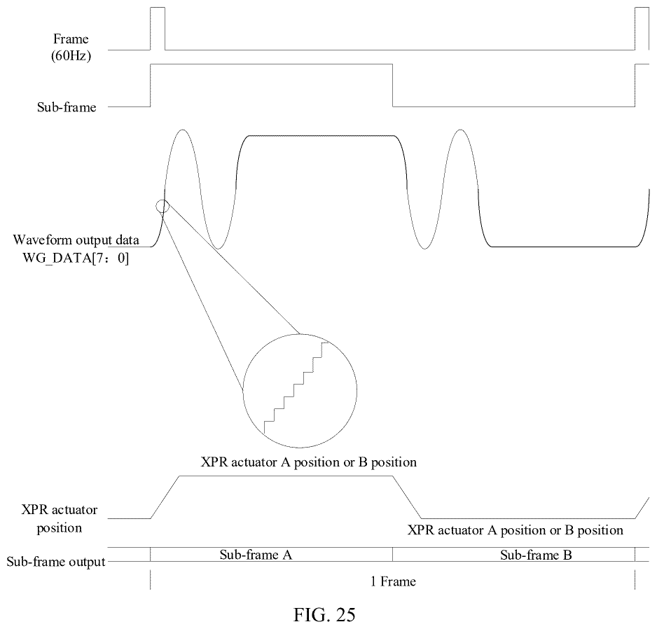

In addition, FIG. 25 illustrates a schematic diagram of a waveform output working principle according to some embodiments. As shown in FIG. 25, after the rising edge of the delayed sub-frame signal arrives, the amplitude values are read from the lookup table in a forward sequence, and the number of amplitude values specified by the preset segment number in the lookup table are output in sequence. The last amplitude value in the lookup table is continuously output until the falling edge of the delayed sub-frame signal arrives, at which point the amplitude values in the lookup table are read in a reverse sequence or read in a reverse sequence with complement, and the number of amplitude values specified by the target segment number in the lookup table are output in sequence. The final output waveform data WG_DATA [7:0] is subjected to digital-to-analog conversion by a digital-to-analog converter and amplification by an operational amplifier, and finally outputs an XPR actuator driving waveform. This XPR actuator driving waveform is an analog signal waveform with driving capability. Triggered by the rising edge of the delayed sub-frame signal, the digital driving waveform starts to be output in a forward sequence, thereby outputting the XPR actuator driving waveform (i.e., the analog driving waveform) to drive the XPR actuator to start moving, such that the XPR actuator moves to position A or position B, where sub-frame A is synchronously output. When the falling edge of the delayed sub-frame signal arrives, the digital driving waveform starts to be output in reverse sequence, driving the XPR actuator to move to position B or position A, where sub-frame B is output. Therefore, in the display of one frame of image, the XPR actuator moves to two positions, corresponding to the output of sub-frame A or sub-frame B at different positions. As a result, the number of pixels displayed in the one frame of image is doubled, and the resolution is increased to twice the original resolution. It should be noted that when the position to which the XPR actuator moves does not correspond to the sub-frame, the target XPR actuator type may be configured to enable the moving position of the XPR actuator to correspond to the sub-frame.

The digital waveform generation module of the XPR actuator provided in the embodiments of the present disclosure first delays the sub-frame signal through the sub-frame delay sub-module to ensure that when the generated digital driving waveform signal drives the XPR actuator, the display of the sub-image is synchronized with the movement of the XPR actuator. By combining the plurality of amplitude values of the digital driving waveform corresponding to the analog driving waveform required to drive the XPR actuator stored in the amplitude storage sub-module, the address control sub-module reads the target number of amplitude values from the amplitude storage sub-module according to the target XPR actuator type, and uses the control clock provided by the clock control sub-module and the target segment length to limit the duration of amplitude value output, thereby enabling the plurality of amplitude values to form a digital driving waveform that approximates the analog driving waveform. Therefore, based on the rising edge or falling edge of the delayed sub-frame signal, the embodiments of the present disclosure trigger the address control sub-module to read and output the plurality of amplitude values of the digital driving waveform from the amplitude storage sub-module, forming a digital driving waveform containing the plurality of amplitude values, which can enable the XPR actuator to move to the accurate position required for image display with low noise and better image quality.

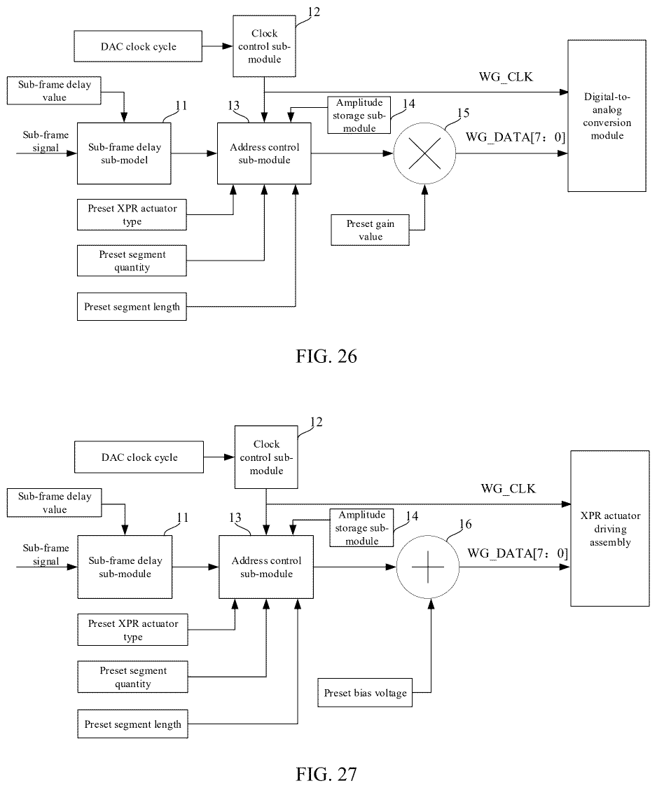

In some embodiments, as shown in FIG. 26, the digital waveform generation module of the XPR actuator further includes a multiplication sub-module 15. The multiplication sub-module 15 is connected to the address control sub-module 13, and the address control sub-module 13 is used to output a digital driving waveform signal to the multiplication sub-module 15. The multiplication sub-module 15 is used to multiply the digital driving waveform signal by a first gain value, such that the amplitude value of the digital driving waveform signal reaches the desired amplitude value corresponding to the analog driving waveform. In one implementation, the multiplication sub-module 15 is also connected to the digital-to-analog conversion module (either directly or through the level conversion module), and the multiplication sub-module 15 is configured to transmit the amplitude-adjusted digital driving waveform signal to the digital-to-analog conversion module.

In one possible implementation, the multiplication sub-module 15 may include a multiplier. Since the amplitude values read and output from the lookup table cannot reach the desired amplitude value of the simulated driving waveform, the first gain value may be edited based on the multiple relationships between the desired amplitude value of the simulated driving waveform and the amplitude values in the lookup table. The digital driving waveform, specifically each amplitude value of the digital driving waveform, is multiplied by the first gain value through the multiplication sub-module 15, such that the amplitude value of the digital driving waveform output through the multiplication sub-module 15 can reach the desired amplitude value of the simulated driving waveform, thereby improving the accuracy of the movement position of the XPR actuator. For example, the first gain value may be a preset gain value, or may be an 8-bit unsigned number with a value range of, for example, 0 to 1.9921875.

In some embodiments, as shown in FIG. 27, the digital waveform generation module of the XPR actuator further includes an addition sub-module 16. The addition sub-module 16 is connected to the address control sub-module 13, and is used to apply a first bias voltage to the digital driving waveform to adjust the central deflection angle of the XPR actuator during deflection. In one implementation, the addition sub-module 16 is also connected to the digital-to-analog conversion module (either directly or through the level conversion module), and is used to transmit the amplitude-adjusted digital driving waveform signal to the digital-to-analog conversion module.

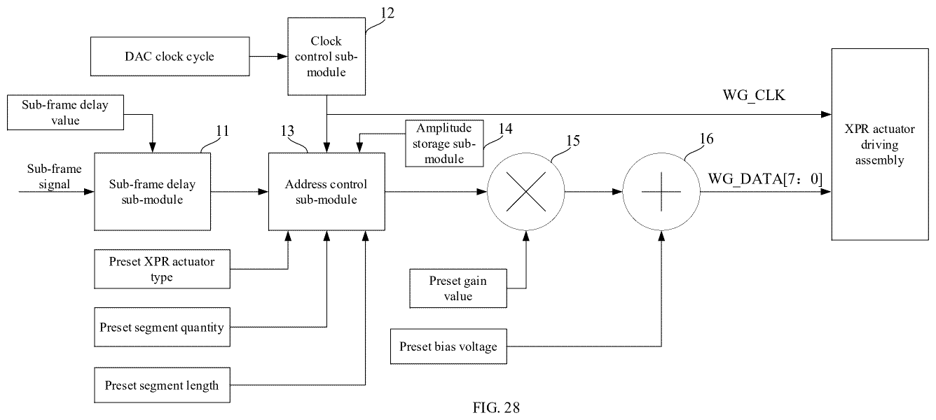

Typically, the central deflection angle of the XPR actuator is 0, meaning that the XPR actuator pivots around the axis with a deflection angle of 0 degrees and deflects between symmetrical positive and negative deflection angles. However, depending on practical applications, the XPR actuator may be made to deflect only in the positive deflection angle range. In this case, a first bias voltage needs to be applied to the digital driving waveform signal through an additional sub-module 16 (such as an adder) to ensure that the deflection of the XPR actuator meets the requirements of practical applications. In one embodiment, referring to FIG. 27, the addition sub-module 16 may be directly connected to the address control sub-module 13. In another embodiment, referring to FIG. 28, the addition sub-module 16 may be connected to the address control sub-module 13 through a multiplication sub-module 15. Similarly, in yet another embodiment, the positions of the multiplication sub-module 15 and the addition sub-module 16 in FIG. 28 may be interchanged, meaning that the multiplication sub-module 15 may be connected to the address control sub-module 13 through the addition sub-module 16.

The first bias voltage may be a preset bias voltage, or it may be a 5-bit unsigned number with a value range of 0 to 32.

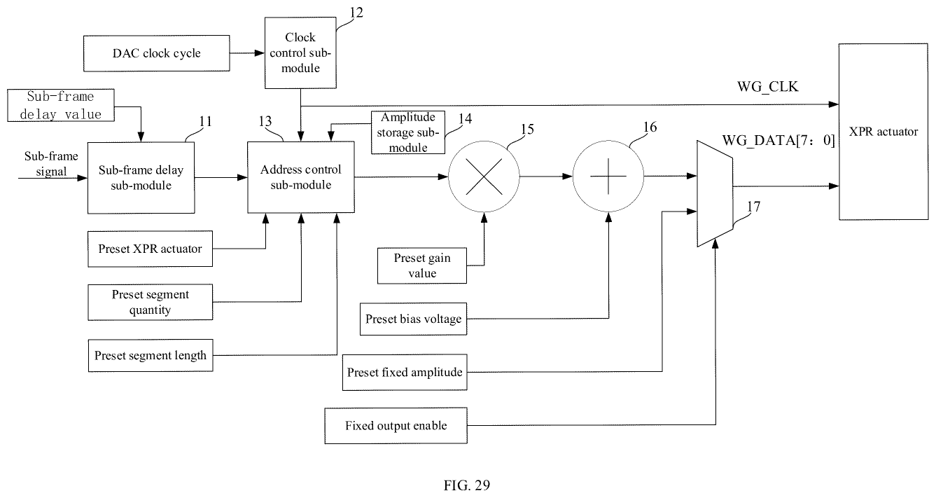

In some embodiments, as shown in FIG. 29, the digital waveform generation module of the XPR actuator further includes a select sub-module 17. The select sub-module 17 includes two input terminals and one output enable terminal. For ease of distinction, in some embodiments, these two input terminals may be referred to as a first input terminal and a second input terminal, respectively, and the output enable terminal may be referred to as a fixed output enable terminal. It should be understood that the first and second input terminals here are input terminals of different devices from those mentioned above, and are not the same input terminals. The first input terminal of the select sub-module 17 is connected to the address control sub-module 13 (in the example shown in FIG. 29, the first input terminal of the select sub-module 17 is connected to the address control sub-module 13 through the addition sub-module 16 and the multiplication sub-module 15), and the second input terminal of the select sub-module 17 is connected to a first fixed amplitude value; the select sub-module 17 is used to output a digital driving waveform signal to drive the XPR actuator to deflect if the enable signal of the fixed output enable terminal is invalid (i.e., the fixed output enable is invalid), and to output the first fixed amplitude value to turn off the XPR actuator if the enable signal of the fixed output enable terminal is valid (i.e., the fixed output enable is valid). The first fixed amplitude value may be a preset fixed amplitude value, which may be an 8-bit unsigned number with a value range of, for example, 0 to 255.

Illustratively, based on the actual needs of the user, if the user wants to display images at a higher resolution, the XPR actuator may be turned on by the user. At this time, the fixed output is disabled, and the digital driving waveform is output normally, driving the XPR actuator to deflect back and forth at two different positions, thus improving the display resolution. If the user wants to display images at the original resolution (the resolution of the projection device), the XPR actuator may be turned off by the user. At this time, the fixed output is enabled, and a preset fixed amplitude value is output. The XPR actuator no longer deflects, and the resolution remains unchanged.

In summary, the XPR actuator driving device and the laser projection device provided in the embodiments of the present disclosure control the power supply of the XPR actuator driving circuit through a DLP unit circuit, a delay circuit, and a switch circuit. The DLP unit circuit can only output a configuration success command signal to the delay circuit when the configuration is successful. At this time, the DLP unit circuit also outputs an XPR actuator sub-frame synchronization signal to the XPR actuator driving circuit. Upon receiving the configuration success command signal, the delay circuit outputs a turn-on signal to the control terminal of the switch circuit after a certain delay, enabling the power supply to supply power to the XPR actuator driving circuit. By setting this delay, it can be ensured that the XPR actuator sub-frame synchronization signal is transmitted to the XPR actuator driving circuit first, and then the power supply supplies power to the XPR actuator driving circuit. This can avoid the phenomenon of the XPR actuator coil being burned due to the direct current high-voltage pulse generated by connecting the power supply before the XPR actuator sub-frame synchronization signal is transmitted to the XPR actuator driving circuit. Thus, the problem of the XPR actuator coil being easily burned is solved, and the reliability of the laser projection device is improved.

The XPR actuator driving circuit may include a digital-to-analog conversion module, a digital waveform generation module, and an operational amplifier module. The operational amplifier module is used to divide the analog driving waveform signal into two, obtaining a first driving voltage and a second driving voltage with opposite phases. The first driving voltage is applied to the positive terminal of the coil of the XPR actuator, and the second driving voltage is applied to the negative terminal of the coil. The voltage driving of the XPR actuator is achieved by using the difference between the first driving voltage and the second driving voltage. In this way, the XPR actuator driving circuit provided in the embodiment of the present disclosure only requires one voltage generation circuit (corresponding to the digital waveform generation module of the present disclosure). The analog driving waveform signal generated by the digital waveform generation module and converted by the digital-to-analog conversion module is processed by the operational amplifier module into two driving voltages with opposite phases. The voltage driving of the XPR actuator is achieved by using the difference between the two driving voltages, thereby driving the XPR actuator to deflect. This saves one voltage generation circuit and reduces the cost of the XPR actuator driving circuit.

The digital waveform generation module includes a sub-frame delay sub-module, a clock control sub-module, an address control sub-module, and an amplitude storage sub-module. Firstly, the sub-frame signal is delayed by the sub-frame delay sub-module to ensure that when the generated digital driving waveform signal, after passing through the digital-to-analog conversion module and the operational amplifier module, drives the XPR actuator, the display of the sub-image is synchronized with the movement of the XPR actuator. By combining the plurality of amplitude values of the digital driving waveform signal corresponding to the analog driving waveform signal required to drive the XPR actuator, stored by the amplitude storage sub-module, the address control sub-module reads the target number of amplitude values from the amplitude storage sub-module according to the target XPR actuator type. The control clock provided by the clock control sub-module and the target segment length limit the duration of amplitude value output, thereby enabling the plurality of digital amplitude values to form a digital driving waveform signal that approximates an analog driving waveform signal. Thus, based on the rising edge or falling edge of the delayed sub-frame signal, the address control sub-module triggers the reading and outputting of the plurality of amplitude values of the digital driving waveform signal from the amplitude storage sub-module, forming a digital driving waveform signal containing the plurality of digital amplitude values, which enables the XPR actuator to move to the accurate position required for image display.

The embodiments of the present disclosure also provide a laser projection device. The laser projection device includes an XPR actuator, and the XPR actuator driving device provided in any of the above embodiments. The XPR actuator driving device is connected to the XPR actuator.

In one possible implementation, the XPR actuator driving device includes an XPR actuator power control circuit and an XPR actuator driving circuit. That is, the embodiments of the present disclosure also provide a laser projection device, which includes an XPR actuator, an XPR actuator driving circuit, and the XPR actuator power control circuit provided in the above embodiment. The output terminal of the XPR actuator power control circuit is connected to the power input terminal of the XPR actuator driving circuit, and the output terminal of the XPR actuator driving circuit is connected to the XPR actuator coil. The XPR actuator power control circuit includes a DLP unit circuit, a delay circuit, and a switch circuit. The XPR actuator driving circuit may be any of the XPR actuator driving circuits provided in the above embodiments.

In one possible implementation, the laser projection device further includes a light source driving assembly, a light source, a light valve, and a lens. The XPR actuator driving device is also connected to the light source driving assembly and the light valve, respectively. The light source driving assembly is also connected to the light source. The light valve is disposed on the light-output side of the light source, the XPR actuator is disposed on the light-output side of the light valve, and the lens is disposed on the light-output side of the XPR actuator. The XPR actuator may be the XPR actuator shown in FIG. 7.

The laser projection device provided in the embodiments of the present disclosure has the same technical features as the XPR actuator driving device provided in the aforementioned embodiment of the present disclosure, and thus can also solve the same technical problems and achieve the same technical effects.

The embodiments of the present disclosure further provide a method for driving an XPR actuator. The method may be applied to any of the laser projection devices provided in the aforementioned embodiments, specifically to an XPR actuator driving device in the laser projection device. The XPR actuator driving device is any of the XPR actuator driving devices provided in the aforementioned embodiments. The method includes: transmitting, in the case where a DLP unit circuit is successfully configured, an XPR actuator sub-frame synchronization signal; and supplying, after a first delay, power to the XPR actuator driving circuit. The XPR actuator sub-frame synchronization signal is used to instruct the XPR actuator driving circuit to drive the XPR actuator to deflect.

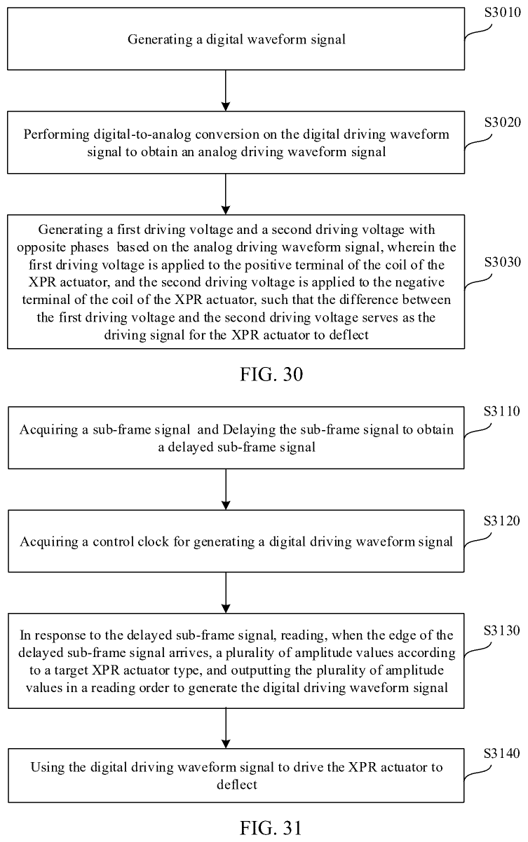

In one possible implementation, after transmitting the sub-frame synchronization signal of the XPR actuator, as shown in FIG. 30, the method further includes the following steps:

In S3010, a digital waveform signal is generated.

The digital waveform signal includes a digital driving waveform signal.

In S3020, digital-to-analog conversion is performed on the digital driving waveform signal to obtain an analog driving waveform signal.

In S3030, a first driving voltage and a second driving voltage with opposite phases are generated based on the analog driving waveform signal, the first driving voltage is applied to the positive terminal of the coil of the XPR actuator, and the second driving voltage is applied to the negative terminal of the coil of the XPR actuator, such that the difference between the first driving voltage and the second driving voltage serves as the driving signal for the XPR actuator to deflect.

The XPR actuator driving circuit provided in the embodiments of the present disclosure may be used to perform the method for driving the XPR actuator described therein. Specific steps may be referred to the functions of relevant modules in the XPR actuator driving circuit, which will not be further repeated here.

In one possible implementation, after transmitting the sub-frame synchronization signal of the XPR actuator, as shown in FIG. 31, the method further includes the following steps:

In S3110, a sub-frame signal is acquired, and the sub-frame signal is delayed to obtain a delayed sub-frame signal.

The sub-frame signal includes the sub-frame signals of two frames of sub-image obtained by decomposing one frame of image, and the delayed sub-frame signal is used to synchronize the display of the sub-images with the movement of the XPR actuator.

In S3120, a control clock for generating a digital driving waveform signal is acquired.

In S3130, in response to the delayed sub-frame signal, when the edge of the delayed sub-frame signal arrives, a plurality of amplitude values are read according to a target XPR actuator type, and the plurality of amplitude values are output in a reading order to generate the digital driving waveform signal.

The first to the second last amplitude values read are all output with the target segment length, and the last amplitude value read is output until the next edge of the delayed sub-frame signal arrives. The target XPR actuator type indicates the reading method of the amplitude values, and the target segment length indicates the clock length of a plurality of control clocks.

In S3140, the digital driving waveform signal is used to drive the XPR actuator to deflect.

In some embodiments, the aforementioned step 3010 may include steps S3110 to S3130. In other embodiments, the aforementioned step 3010 may also include other steps, i.e., generating the digital driving waveform signal in other ways.

In some embodiments, the aforementioned step 3140 may include steps S3020 to S3030. In other embodiments, step 3140 may also include other steps, i.e., using other methods to drive the XPR actuator to deflect.

The aforementioned two frames of sub-image include a first sub-image and a second sub-image. In some embodiments, reading the plurality of amplitude values according to the target XPR actuator type includes:
reading, based on a first XPR actuator type of the first sub-image, the plurality of amplitude values in a forward sequence from an amplitude storage sub-module;
reading, based on a second XPR actuator type of the second sub-image, the plurality of amplitude values from the amplitude storage sub-module in reverse sequence; or, inverting each of the plurality of amplitude values in the amplitude storage sub-module, and reading the inverted plurality of amplitude values from the amplitude storage sub-module in a forward sequence.

In some embodiments, after outputting the plurality of amplitude values in the reading order to generate the digital driving waveform signal, the method further includes:
multiplying the digital driving waveform signal by a first gain value, such that the amplitude value of the digital driving waveform signal reaches the desired amplitude value corresponding to the analog driving waveform signal; and/or,
applying a first bias voltage to the digitally driven waveform signal to adjust the central deflection angle of the XPR actuator during the deflection process.

In some embodiments, the method further includes:
outputting the digital driving waveform signal in response to the XPR actuator startup operation; and
outputting the first fixed amplitude value output in response to the XPR actuator shutdown operation.

The XPR actuator driving method provided in the embodiments of the present disclosure may be implemented using the XPR actuator driving apparatus provided in the embodiments of the present disclosure. The specific steps may refer to the functions of the relevant modules in the XPR actuator driving apparatus, and will not be repeated here.

The embodiments of the present disclosure further provide a non-transitory computer-readable storage medium storing at least one computer program or at least one program instruction. When the at least one computer program or at least one program instruction executed by a processor, causes the processor to perform the method for driving the XPR actuator as shown in any of the above method embodiments, with similar specific implementation methods and technical effects, which will not be further repeated here.

In a specific implementation, the computer-readable storage medium may include various media capable of storing program code, such as USB flash drives, external hard drives, ROMs, RAMs, magnetic disks, or optical discs.

The embodiments of the present disclosure also provide a computer program product. The computer program product includes at least one computer program or at least one instruction. The at least one computer program or at least one instruction is stored in a computer-readable storage medium, and the laser projection device can read the at least one computer program or at least one instruction from the computer-readable storage medium and execute the read at least one computer program or at least one instruction to perform method for driving the XPR actuator as shown in any of the method embodiments above. The specific implementation methods and technical effects are similar and will not be further repeated here.

Lastly, it should be noted that the above embodiments are merely used to illustrate the technical solutions of the present disclosure, and are not intended to limit them. Despite the detailed description of the present disclosure with reference to the aforementioned embodiments, those skilled in the art should understand that they can still modify the technical solutions described in the aforementioned embodiments, or equivalently, replace some or all of the technical features. Such modifications or replacements do not alter the essence of the corresponding technical solutions beyond the scope of the technical solutions of the embodiments of the present disclosure.

For ease of explanation, the above description has been provided in conjunction with specific embodiments. However, the exemplary discussion above is not intended to be exhaustive or to limit the embodiments to the specific forms disclosed. Based on the teachings provided above, various modifications and variations can be derived. The selection and description of the embodiments above are intended to better explain the principles and practical applications, thereby enabling those skilled in the art to better utilize the embodiments and various different variations of the embodiments suitable for specific usage considerations.

The serial numbers of the embodiments mentioned above are solely for descriptive purposes and do not indicate the superiority or inferiority of the embodiments.

Those skilled in the art can understand that all or part of the steps for implementing the above embodiments can be accomplished through hardware, or can be instructed to relevant hardware through a program. The program can be stored in a computer-readable storage medium, and the aforementioned storage medium can be a read-only memory, a magnetic disk, an optical disk, or the like.

Described above are merely preferred embodiments of the present disclosure and are not intended to limit the present disclosure. Any modifications, equivalent substitutions, improvements, or the like, made within the spirit and principle of the present disclosure should fall within the protection scope of the present disclosure.

1. An extended pixel resolution (XPR) actuator driving apparatus, comprising a digital light processing (DPL) unit circuit, a delay circuit, a switch circuit, and an XPR actuator driving circuit; wherein a command signal output terminal of the DLP unit circuit is connected to an input terminal of the delay circuit, a sub-frame synchronization signal output terminal of the DLP unit circuit is connected to the XPR actuator driving circuit, an output terminal of the delay circuit is connected to a control terminal of the switch circuit, an input terminal of the switch circuit is connected to a power supply of the XPR actuator driving circuit, and an output terminal of the switch circuit is connected to a power input terminal of the XPR actuator driving circuit;
the DLP unit circuit is configured to output, in response to the DLP unit circuit being successfully configured, a configuration success command signal through the command signal output terminal, and an XPR actuator sub-frame synchronization signal through the sub-frame synchronization signal output terminal, wherein the XPR actuator sub-frame synchronization signal instructs the XPR actuator driving circuit to drive an XPR actuator to deflect;
the delay circuit is configured to output, in response to the input terminal of the delay circuit receiving the configuration success command signal, a turn-on signal through the output terminal of the delay circuit after a first delay; and
the switch circuit is configured to establish, in response to the control terminal of the switch circuit receiving the turn-on signal, an electrical connection between the input terminal of the switch circuit and the output terminal of the switch circuit.

2. The XPR actuator driving apparatus according to claim 1, wherein the delay circuit further comprises an abnormal signal port configured to receive an abnormal signal, the abnormal signal indicating a fan failure and/or apparatus overheat; and
the delay circuit is configured to output, in response to the input terminal of the delay circuit receiving the configuration success command signal and the abnormal signal port does not receive the abnormal signal, the turn-on signal through the output terminal of the delay circuit after the first delay;
wherein the abnormal signal port comprises a fan fault signal port and/or an overheat signal port, wherein the fan fault signal port is configured to receive a fan fault signal, and the overheat signal port is configured to receive an overheat signal, and the abnormal signal comprises the fan fault signal and/or the overheat signal, the fan fault signal indicating a fan fault, and the overheat signal indicating apparatus overheat.

3. The XPR actuator driving apparatus according to claim 1, wherein the DLP unit circuit comprises a master control DLP chip and a slave DLP chip;
the DLP unit circuit is configured to output, in response to both the master control DLP chip and the slave DLP chip being successfully configured, the configuration success command signal through the command signal output terminal; and
the DLP unit circuit further comprises a first transistor, a second transistor, and an AND gate circuit; wherein
the first transistor is configured to output, in response to a low-level configuration success signal output by the master control DLP chip being received, a high-level configuration success command signal to one input terminal of the AND gate circuit;
the second transistor is configured to output, in response to a low-level configuration success signal output by the slave DLP chip being received, a high-level configuration success command signal to another input terminal of the AND gate circuit; and
the AND gate circuit is configured to output, in response to both input terminals of the AND gate circuit receiving the high-level configuration success command signal, the configuration success command signal to the input terminal of the delay circuit.

4. The XPR actuator driving apparatus according to claim 1, wherein the XPR actuator driving circuit comprises a digital waveform generation module, a digital-to-analog conversion module, an operational amplifier module; wherein the sub-frame synchronization signal output terminal is connected to the digital waveform generation module, the digital waveform generation module is further connected to the digital-to-analog conversion module, the digital-to-analog conversion module is further connected to the operational amplifier module, and the operational amplifier module is further connected to a positive terminal and a negative terminal of a coil of the XPR actuator;
the digital waveform generation module is configured to generate a digital waveform signal in response to receiving the XPR actuator sub-frame synchronization signal, and transmit the digital waveform signal to the digital-to-analog conversion module, wherein the digital waveform signal comprises a digital driving waveform signal;
the digital-to-analog conversion module is configured to perform digital-to-analog conversion on the digital driving waveform signal to obtain an analog driving waveform signal, and transmit the analog driving waveform signal to the operational amplifier module; and
the operational amplifier module is configured to generate a first driving voltage and a second driving voltage with opposite phases based on the analog driving waveform signal, and transmit the first driving voltage to the positive terminal of the coil and the second driving voltage to the negative terminal of the coil, wherein a difference between the first driving voltage and the second driving voltage is a driving signal of the XPR actuator, wherein the driving signal is configured to drive the XPR actuator to deflect.

5. The XPR actuator driving apparatus according to claim 4, wherein the operational amplifier module comprises a first operational amplifier and a second operational amplifier; an output terminal of the digital-to-analog conversion module for outputting the analog driving waveform signal is connected to an inverting input terminal of the first operational amplifier and a non-inverting input terminal of the second operational amplifier, respectively, an output terminal of the first operational amplifier is connected to the positive terminal of the coil, and an output terminal of the second operational amplifier is connected to the negative terminal of the coil; wherein the first operational amplifier is configured to amplify the analog driving waveform signal in phase, and the second operational amplifier is configured to amplify the analog driving waveform signal in anti-phase.

6. The XPR actuator driving apparatus according to claim 4, wherein the digital waveform signal further comprises a waveform output clock signal and a waveform output enable signal, wherein the waveform output clock signal is configured to provide a control clock for generating the digital driving waveform signal, and the waveform output enable signal instructs the digital-to-analog conversion module to perform the digital-to-analog conversion on the digital driving waveform signal and output the analog driving waveform signal.

7. The XPR actuator driving apparatus according to claim 4, wherein the XPR actuator driving circuit further comprises a level conversion module; wherein the level conversion module is connected to the digital waveform generation module and the digital-to-analog conversion module, respectively; and
the level conversion module is configured to convert a logic level of the digital waveform signal to match an operating level of the digital-to-analog conversion module.

8. The XPR actuator driving apparatus according to claim 4, wherein the delay circuit is configured to shut off a power supply powering the operational amplifier module in response to an abnormal signal from an abnormal signal port, thereby shutting down the XPR actuator.

9. The XPR actuator driving apparatus according to claim 1, wherein the XPR actuator driving circuit comprises a digital waveform generation module, wherein the digital waveform generation module comprises a sub-frame delay sub-module, a clock control sub-module, an address control sub-module, and an amplitude storage sub-module; wherein the sub-frame delay sub-module, the clock control sub-module, and the amplitude control sub-module are all connected to the address control sub-module;
the sub-frame delay sub-module is configured to delay a sub-frame signal to obtain a delayed sub-frame signal, and transmit the delayed sub-frame signal to the address control sub-module, wherein the sub-frame signal is a sub-frame signal of two frames of sub-image obtained by decomposing one frame of image, and the delayed sub-frame signal is configured to synchronize a display of the sub-image with a movement of the XPR actuator;
the clock control sub-module is configured to provide the address control sub-module with a control clock for generating a digital driving waveform signal, wherein the digital driving waveform signal is configured to drive the XPR actuator to deflect;
the amplitude storage sub-module is configured to store a plurality of amplitude values of the digital driving waveform signal; and
the address control sub-module is configured to read, in response to the delayed sub-frame signal, the plurality of amplitude values from the amplitude storage sub-module according to a target XPR actuator type when an edge of the delayed sub-frame signal arrives, and output the plurality of amplitude values in a reading order to generate the digital driving waveform signal, wherein a first to a second-to-last amplitude values read are continuously output with a target segment length, and a last amplitude value read is continuously output until a next edge of the delayed sub-frame signal arrives, the target XPR actuator type indicates a reading method of the amplitude values, and the target segment length indicates a clock length of a plurality of control clocks, the edge being a rising edge or a falling edge.

10. The XPR actuator driving apparatus according to claim 9, wherein the digital waveform generation module further comprises a multiplication sub-module, and the XPR actuator driving circuit further comprises a digital-to-analog conversion module; wherein the multiplication sub-module is connected to the address control sub-module and the digital-to-analog conversion module, respectively;
the address control sub-module is further configured to output the digital driving waveform signal to the multiplication sub-module;
the multiplication sub-module is configured to multiply the digital driving waveform signal by a first gain value, to enable an amplitude value of the digital driving waveform signal to reach a desired amplitude value corresponding to an analog driving waveform signal; and
the digital-to-analog conversion module is configured to perform digital-to-analog conversion on the digital driving waveform signal to obtain the analog driving waveform signal, wherein the analog driving waveform signal is configured to drive the XPR actuator to deflect.

11. The XPR actuator driving apparatus according to claim 9, wherein the digital waveform generation module further comprises an addition sub-module, wherein the addition sub-module is connected to the address control sub-module; and
the addition sub-module is configured to apply a first bias voltage to the digital driving waveform signal, to adjust a central deflection angle of the XPR actuator during deflection.

12. The XPR actuator driving apparatus according to claim 9, wherein the digital waveform generation module further comprises a select sub-module, wherein one input terminal of the select sub-module is connected to the address control sub-module to receive the digital driving waveform signal, and another input terminal of the select sub-module is connected to a first fixed amplitude value; and
the select sub-module is configured to output the digital driving waveform signal to drive the XPR actuator to deflect in response to an enable signal of a fixed output enable terminal of the select sub-module being invalid, and to output the first fixed amplitude value to turn off the XPR actuator in response to the enable signal of the fixed output enable terminal of the select sub-module being valid.

13. A laser projection device, comprising an extended pixel resolution (XPR) actuator, and the XPR actuator driving apparatus as defined in claim 1, wherein the XPR actuator driving apparatus is connected to the XPR actuator.

14. The laser projection device according to claim 13, further comprising a light source driving assembly, a light source, a light valve, and a lens; wherein the XPR actuator driving device is further connected to the light source driving assembly and the light valve, respectively; the light source driving assembly is further connected to the light source; the light valve is disposed on a light-output side of the light source; the XPR actuator is disposed on a light-output side of the light valve; and the lens is disposed on a light-output side of the XPR actuator.

15. The laser projection device according to claim 13, wherein the XPR actuator comprises a base, a fixing plate, a spring plate, a swinging member, and an optical lens; wherein
the base has a first hollowed-out region, one side of the base is provided with two pillars disposed at two ends of a diagonal line of the first hollowed-out region, one side of the base is further provided with a magnetic component disposed at one edge of the first hollowed-out region, the magnetic component comprising a coil and a magnet, and an end of the base is provided with a connector, the connector being connected to the coil and an output terminal of the XPR actuator driving circuit, respectively;
the fixing plate is disposed on a side of the base opposite to the magnetic component, and the fixing plate has a second hollowed-out region, and the fixing plate is configured to fix the base; and
the spring plate is fixed on the two pillars, and the swinging member is arranged on the spring plate with the two pillars as a fulcrum, the swinging member has a third hollowed-out region configured to support the optical lens, and an orthographic projection of the optical lens on the base and an orthographic projection of the second hollowed-out region on the base both overlap with the first hollowed-out region.

16. A method for driving an extended pixel resolution (XPR) actuator, comprising:
transmitting, in response to a digital light processing (DLP) unit circuit being successfully configured, an XPR actuator sub-frame synchronization signal; and supplying, after a first delay, power to an XPR actuator driving circuit, wherein the XPR actuator sub-frame synchronization signal instructs the XPR actuator driving circuit to drive an XPR actuator to deflect.

17. The method according to claim 16, wherein after transmitting the XPR actuator sub-frame synchronization signal, the method further comprises:
generating a digital waveform signal, wherein the digital waveform signal comprises a digital driving waveform signal;
obtaining an analog driving waveform signal by performing digital-to-analog conversion on the digital driving waveform signal; and
generating a first driving voltage and a second driving voltage with opposite phases based on the analog driving waveform signal, applying the first driving voltage to a positive terminal of a coil of the XPR actuator, and applying the second driving voltage to a negative terminal of the coil of the XPR actuator, to enable a difference between the first driving voltage and the second driving voltage to serve as a driving signal for the XPR actuator, to drive the XPR actuator to deflect.

18. The method according to claim 16, wherein after transmitting the XPR actuator sub-frame synchronization signal, the method further comprises:
acquiring a sub-frame signal and delaying the sub-frame signal to obtain a delayed sub-frame signal, wherein the sub-frame signal comprises a sub-frame signal of two frames of sub-image obtained by decomposing one frame of image, the delayed sub-frame signal is configured to synchronize a display of the sub-image with a movement of the XPR actuator;
acquiring a control clock for generating a digital driving waveform;
reading a plurality of amplitude values according to a target XPR actuator type when an edge of the delayed sub-frame signal arrives, and outputting the plurality of amplitude values in a reading order to generate the digital driving waveform signal, wherein a first to a second-to-last amplitude values read are continuously output with a target segment length, and a last amplitude read is continuously output until a next edge of the delayed sub-frame signal arrives, the target XPR actuator type indicates a reading method of the amplitude values, and the target segment length indicates a clock length of a plurality of control clocks; and
using the digital driving waveform signal to drive the XPR actuator to deflect.

19. The method according to claim 18, wherein the two frames of sub-image comprise a first sub-image and a second sub-image; and
said reading the plurality of amplitude values according to the target XPR actuator type comprises:
reading, based on a first XPR actuator type of the first sub-image, the plurality of amplitude values in a forward sequence from an amplitude storage sub-module; and
reading, based on a second XPR actuator type of the second sub-image, the plurality of amplitude values from the amplitude storage sub-module in a reverse sequence; or, inverting each of the plurality of amplitude values in the amplitude storage sub-module, and reading the inverted plurality of amplitude values from the amplitude storage sub-module in the forward sequence.

20. A non-transitory computer-readable storage medium storing at least one instruction, at least one program, a code set, or an instruction set, wherein the at least one instruction, the at least one program, the code set, or the instruction set is loaded and executed by a processor to perform the method as defined in claim 16.
